(19) United States
(12) Patent Application Publication
(10) Pub. No.: US 2022/0253784 A1
(43) Pub. Date: Aug. 11, 2022

(54) INTERACTIVE AND PREDICTIVE TOOL FOR MONITORING PERFORMANCE METRICS

(71) Applicant: Steve Mullinjer, Dallas, TX (US)

(72) Inventor: Steve Mullinjer, Dallas, TX (US)

(21) Appl. No.: 17/619,461

(22) PCT Filed: Jun. 18, 2020
(86) PCT No.: PCT/IB2020/055755

§ 371 Date: Dec. 15, 2021

Related U.S. Application Data
(60) Provisional application No. 62/865,032, filed on Jun. 21, 2019.

(51) Int. Cl. G06Q 10/06

(52) U.S. Cl. CPC G06Q 10/06393

(57) ABSTRACT

The present disclosure provides a method, system, and computer-readable medium for using a predictive analytics engine to dynamically modify an interactive tool. To illustrate, a method includes compiling candidate data. The method includes initializing a predictive analytics engine based on at least a portion of the compiled candidate data and a conceptual performance model representative of an expected performance over a period of time. The method includes processing, by the predictive analytics engine, a plurality of performance metrics to produce one or more predictive performance metrics. The method further includes dynamically modifying an interactive tool based on the conceptual performance model and the plurality of performance metrics.

### CROSS REFERENCE TO RELATED APPLICATIONS

This application claims the benefit of priority of U.S. Provisional Patent Application No. 62/865,032, filed Jun. 21, 2019, which is hereby incorporated by reference in its entirety.

### TECHNICAL FIELD

The present application is generally related to the technical field of performance metric monitoring, and more particularly, but not by way of limitation, to techniques for an interactive tool for monitoring performance metrics.

### BACKGROUND

When choosing a Chief Executive Officer (CEO) for a corporation, many Boards (e.g., Boards of Directors) focus on what are characteristically described as “hard” performance criteria. These hard performance criteria are measurable values that demonstrate how effectively a corporation is achieving its commercial objectives. The focus of these measures is predominately on tangible economic or numeric data. Such focus omits “soft” criteria, which are harder to measure and quantify, but no less important in the process of choosing a good CEO and measuring the CEO's performance during their tenure.

Additionally, research into CEO leadership has established certain characteristics that occur during time periods (also referred to as phases or “seasons”) of the CEO's tenure. However, this information is purely descriptive and lacks a predictive nature, making use of the information to predict performance of the CEO difficult. Additionally, such information may be available via research, but is not implemented into an interactive tool to evaluate CEO performance.

### BRIEF SUMMARY

Embodiments of the present disclosure provide systems, methods, and computer-readable storage media that provide for an interactive tool that monitors and displays information related to performance of a CEO. The techniques described herein also provide for a predictive analytics engine that processes performance metrics to generate predictive performance metrics and to modify the interactive tool. The predictive analytics engine may access a plurality of rules to process performance metrics, including aggregating performance metrics, determining indicia (e.g., color ratings) for performance metrics, and generating performance metric indicators that can be visualized by the interactive tool. The predicative analytics engine may be executed at a server that receives the performance metrics and generates the predictive performance metrics, and the interactive tool may be executed at an electronic device, such as a computer or a mobile device. The server (e.g., the predictive analytics engine) may communicate with the electronic device and modify the interactive tool to cause the interactive tool to generate various graphical user interfaces (GUIs) that provide visualizations of the processed performance metrics. The visualizations may enable a user, such as the CEO or a Board member, to understand the relationship between the CEO's performance and an expected performance, as well as the relationships between the CEO's view of his/her tenure and the Board's view, and the relationship between the various performance metrics. Additionally, the information may include predicted values for how the CEO is to perform in the future, which may assist the Board in determining how to improve CEO productivity or how to extend the CEO's tenure or whether it is time to begin a transition to a new CEO.

According to one embodiment, a method for using a predictive analytics engine to dynamically modify an interactive tool is described. The method includes compiling candidate data. The method includes initializing a predictive analytics engine based on at least a portion of the compiled candidate data and a conceptual performance model representative of an expected performance over a period of time. The method also includes processing, by the predictive analytics engine, a plurality of performance metrics to produce one or more predictive performance metrics. The method further includes dynamically modifying an interactive tool based on the conceptual performance model and the plurality of performance metrics.

According to yet another embodiment, a system for using a predictive analytics engine to modify an interactive tool is described. The system includes at least one memory storing instructions and one or more processors coupled to the at least one memory. The one or more processors are configured to execute the instructions to cause the one or more processors compile candidate data. The one or more processors are configured to execute the instructions to cause the one or more processors to initialize a predictive analytics engine based on at least a portion of the compiled candidate data and a conceptual performance model representative of an expected performance over a period of time. The one or more processors are also configured to execute the instructions to cause the one or more processors to process, by the predictive analytics engine, a plurality of performance metrics to produce one or more predictive performance metrics. The one or more processors are further configured to execute the instructions to cause the one or more processors to dynamically modify an interactive tool based on the conceptual performance model and the plurality of performance metrics.

According to another embodiment, a non-transitory computer-readable medium stores instructions that, when executed by a processor, cause the processor to perform operations including compiling candidate data. The operations include initializing a predictive analytics engine based on at least a portion of the compiled candidate data and a conceptual performance model representative of an expected performance over a period of time. The operations also include processing, by the predictive analytics engine, a plurality of performance metrics to produce one or more predictive performance metrics. The operations further include dynamically modifying an interactive tool based on the conceptual performance model and the plurality of performance metrics.

The foregoing has outlined rather broadly the features and technical advantages of the present disclosure in order that the detailed description of the invention that follows may be better understood. Additional features and advantages will be described hereinafter which form the subject of the claims of the present disclosure. It should be appreciated by those skilled in the art that the conception and specific implementations disclosed may be readily utilized as a basis for modifying or designing other structures for carrying out the same purposes of the present disclosure. It should also be realized by those skilled in the art that such equivalent constructions do not depart from the scope of the present disclosure as set forth in the appended claims. The novel features which are believed to be characteristic of the embodiments, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present disclosure, reference is now made to the following descriptions taken in conjunction with the accompanying figures, in which:

FIG. 1 is a block diagram of an example of a system that includes a server including a predictive analytics engine that monitors performance metrics and modifies an interactive tool;

FIG. 2 is an example of a user interface displaying a conceptual performance model and one or more scales;

FIG. 3 is an example of a user interface displaying a plurality of scales;

FIG. 4 is an example of a user interface displaying a conceptual performance model and a plurality of scales;

FIG. 5 is an example of a user interface displaying a conceptual performance model;

FIG. 6 is an example of a user interface displaying a conceptual performance model and a performance measurements window;

FIG. 7 is an example of a user interface displaying multiple sub-category windows;

FIG. 8 is an example of a user interface displaying multiple performance metrics plots;

FIG. 9 is an example of a user interface displaying a three-dimensional rotation of multiple performance metrics plots;

FIG. 10 is an example of a user interface displaying a three-dimensional graph of various performance metrics;

FIG. 11 is an example of a user interface displaying a conceptual performance model and actual performance measurements in addition to a graph of performance metrics;

FIG. 12 is another example of a user interface displaying a conceptual performance model and actual performance measurements in addition to a graph of performance metrics;

FIG. 13 is an example of a user interface displaying a cognitive gearing model;

FIG. 14 is a flow diagram of an example of a method for using a predictive analytics engine to modify an interactive tool; and

FIG. 15 is an example of a user interface displaying CEO performance compared to a conceptual performance model.

### DETAILED DESCRIPTION OF THE INVENTION

Inventive concepts utilize a predictive analytics engine to process performance metrics to generate information relating to performance of a Chef Executive Officer (CEO). The information may include indications of actual performance, which may be compared against a conceptual performance model representative of an expected performance over a period of time. The information may also include predicted performance of the CEO in the future. The predictive analytics engine may implement an algorithm, referred to herein as a Dynamic Leadership Algorithm Model (DYLAM) to process the performance metrics. DYLAM represents a pivotal and paradigmatic shift in the approach to understanding leadership theory and its link to corporate performance. DYLAM addresses issues with other methods of determining CEO performance by incorporating the impact of volatility, uncertainty, complexity, and ambiguity (VUCA+) on CEO tenure in the 21st century, incorporating the need for a dynamic capability that is scalable and capable of customization, incorporating the need for a predictive capability on CEO performance that integrates “hard” and “soft” indicia, and incorporating a mechanism for measuring the degree to which the CEO and the Board of Directors (“the Board”) are fully “synchronized” across all hard and soft key performance indicators (KPIs) over the CEO lifecycle, their quality, consistency, and responsibility (QCR) index. Further, DYLAM provides the CEO and Board the ability to intuitively and interactively explore the multi-layered connections and relationships embedded in the context of the CEO lifecycle, their inter-connectedness, and links to corporate performance.

The predictive analytics engine may modify an interactive tool that is used to display graphical user interfaces (GUIs) that include visualizations of the processed performance metrics. For example, the interactive tool may enable display of GUIs that include CEO performance scales, a conceptual performance model with selectable points that allow additional windows to display performance metrics and sub-category performance metrics, two and three-dimensional (2D and 3D) visualizations of the processed performance metrics, and actual performance values to compare with the conceptual performance model. These visualizations enable a user, such as the CEO or a Board member, to gain insight into the synchronicity between the CEO and the Board, the relationship between the performance metrics, and/or become aware of emergent patterns in the CEO's behavior. In some implementations, the interactive tool may be included in an application executed by a mobile device or other electronic device. The application may provide the CEO and the Board with predictable and actionable insights into the emotional and behavioral characteristics that improve CEO and Board performance. Additionally, the application may help synchronize the Board and CEO's decision matrix on key soft and hard performance dimensions to identify divergences, which may improve the Board's decision quality, consistency, and responsivity (QCR) in a fast changing business environment.

In a particular implementation, the predictive analytics engine is executed at a server, and the interactive tool is executed at an electronic device, such as a computer or a mobile device. Locating the predictive analytics engine at the server may offload a significant amount of processing from the electronic device to the server, which may enable the interactive tool to be executed by electronic devices having less processing power or memory resources, such as a mobile phone. Alternatively, the predictive analytics engine and the interactive tool may both be located at the same device (e.g., at the electronic device or at the server), depending on the capabilities of the device.

The predictive analytics engine may be initialized based on candidate data and a conceptual performance model. The conceptual performance model represents expected performance of the CEO over time. After initialization, the predictive analytics engine processes performance metrics, such as hard KPIs, soft KPIs, and various ratings by the CEO and by the Board, to generate predictive performance metrics and to modify the interactive tool. The predictive performance metrics may indicate predicted behavior of the CEO. Modifying the interactive tool may enable the interactive tool to display updated visualizations of the processed data, which is beneficial to a user, such as the CEO or the Board.

To process the performance metrics, the predictive analytics engine may access one or more stored rules. The rules may include pre-check rules, such as a decision divergence rule (which attempts to prevent Board ratings that are sufficiently dissimilar from being the basis of the processing) and other rules that attempt to prevent disparate ratings from being used without first initiating a reassessment process. The rules may also include processing rules that include rules for converting processed performance metric values to various indicia values. For example, aggregated ratings may be processed to generate a color value, with green representing values that exceed a benchmark, yellow representing values that satisfy the benchmark, and red representing values that are below the benchmark. These indicia may enable a user to quickly and easily interpret a larger volume of information.

Certain units described in this specification have been labeled as modules in order to more particularly emphasize their implementation independence. A module is “[a] self-contained hardware or software component that interacts with a larger system.” Alan Freedman, “The Computer Glossary” 268 (8th ed. 1998). A module may comprise a machine- or machines-executable instructions. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also include software-defined units or instructions, that when executed by a processing machine or device, transform data stored on a data storage device from a first state to a second state. An identified module of executable code may, for instance, comprise one or more physical or logical blocks of computer instructions that may be organized as an object, procedure, or function. Nevertheless, the executables of an identified module need not be physically located together, but may comprise disparate instructions stored in different locations that, when joined logically together, comprise the module, and when executed by the processor, achieve the stated data transformation. A module of executable code may be a single instruction, or many instructions, and may even be distributed over several different code segments, among different programs, and/or across several memory devices. Similarly, operational data may be identified and illustrated herein within modules, and may be embodied in any suitable form and organized within any suitable type of data structure. The operational data may be collected as a single data set, or may be distributed over different locations including over different storage devices.

In the following description, numerous specific details are provided, such as examples of programming, software modules, user selections, network transactions, database queries, database structures, hardware modules, hardware circuits, hardware chips, etc., to provide a thorough understanding of the present embodiments. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the disclosure.

As used herein, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the term “substantially” may be substituted with “within [a percentage] of” what is specified, where the percentage includes 0.1, 1, or 5 percent; and the term “approximately” may be substituted with “within 10 percent of” what is specified. The phrase “and/or” means and or. To illustrate, A, B, and/or C includes: A alone, B alone, C alone, a combination of A and B, a combination of A and C, a combination of B and C, or a combination of A, B, and C. In other words, “and/or” operates as an inclusive or. The phrase “A, B, C, or a combination thereof” or “A, B, C, or any combination thereof” includes: A alone, B alone, C alone, a combination of A and B, a combination of A and C, a combination of B and C, or a combination of A, B, and C.

The terms “comprise” (and any form of comprise, such as “comprises” and “comprising”), “have” (and any form of have, such as “has” and “having”), and “include” (and any form of include, such as “includes” and “including”). As a result, an apparatus that “comprises,” “has,” or “includes” one or more elements possesses those one or more elements, but is not limited to possessing only those one or more elements. Likewise, a method that “comprises,” “has,” or “includes” one or more steps possesses those one or more steps, but is not limited to possessing only those one or more steps.

Any embodiment of any of the systems, methods, and article of manufacture can consist of or consist essentially of—rather than comprise/have/include—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb. Additionally, the term “wherein” may be used interchangeably with “where.”

Further, a device or system that is configured in a certain way is configured in at least that way, but it can also be configured in other ways than those specifically described. The feature or features of one embodiment may be applied to other embodiments, even though not described or illustrated, unless expressly prohibited by this disclosure or the nature of the embodiments.

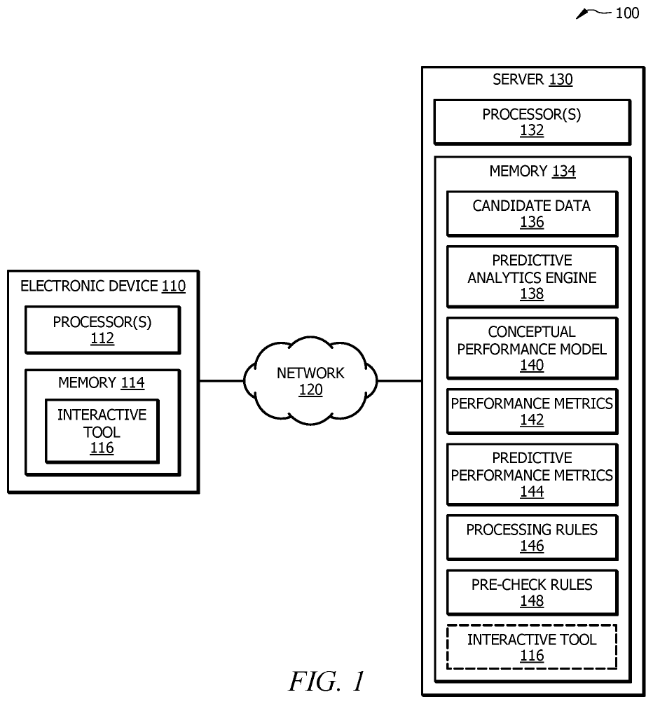

Referring to FIG. 1, a block diagram of a system that includes a server including a predictive analytics engine that monitors performance metrics and modifies an interactive tool is shown and designated 100. System 100 includes an electronic device 110, a network 120, and a server 130.

Electronic device 110 may include a mobile device or a fixed device. In some implementations, electronic device 110 includes a communications device, a fixed location data unit, a mobile location data unit, a mobile phone, a cellular phone, a satellite phone, a computer, a tablet, a portable computer, a display device, a media player, or a desktop computer. Alternatively, or additionally, electronic device 110 may include a set top box, an entertainment unit, a navigation device, a personal digital assistant (PDA), a monitor, a computer monitor, a television, a tuner, a radio, a satellite radio, a music player, a digital music player, a portable music player, a video player, a digital video player, a digital video disc (DVD) player, a portable digital video player, a satellite, a vehicle or a device integrated within a vehicle, any other device that includes a processor or that stores or retrieves data or computer instructions, or a combination thereof. In other illustrative, non-limiting examples, electronic device 110 may include remote units, such as hand-held personal communication systems (PCS) units, portable data units such as global positioning system (GPS) enabled devices, meter reading equipment, or any other device that includes a processor or that stores or retrieves data or computer instructions, or any combination thereof. Although system 100 is shown as having one electronic device 110, in other implementations, system 100 includes multiple electronic devices (e.g., 110).

Electronic device 110 includes one or more processors 112 and a memory 114. One or more processors 112 may include a central processing unit (“CPU”) or microprocessor, a graphics processing unit (“GPU”), and/or microcontroller that has been programmed to perform the functions of electronic device 110. Implementations described herein are not restricted by the architecture of the one or more processors 112 so long as the one or more processors 112, whether directly or indirectly, support the operations described herein. The one or more processors 112 may be one component or multiple components that may execute the various described logical instructions.

Memory 114 includes may read only memory (ROM), random access memory (RAM), one or more HDDs, flash memory devices, SSDs, other devices configured to store data in a persistent or non-persistent state, a combination of different memory devices, or a combination thereof. The ROM may store configuration information for booting electronic device 110. The ROM can include programmable read-only memory (PROM), erasable programmable read-only memory (EPROM), electrically erasable programmable read-only memory (EEPROM), optical storage, or the like. Electronic device 110 may utilize the RAM to store the various data structures used by a software application. The RAM can include synchronous RAM (SRAM), dynamic RAM (DRAM), synchronous dynamic RAM (SDRAM), or the like. The ROM and the RAM hold user and system data, and both the ROM and the RAM may be randomly accessed. In some implementations, memory 114 may store the instructions that, when executed by one or more processors 112, cause the one or more processors 112 to perform operations according to aspects of the present disclosure, as described herein.

Additionally, memory 114 may store an interactive tool 116. Interactive tool 116 may be executed by one or more processors 112 to display a graphical user interface (GUI) that displays information based on performance metrics, as further described herein. In some implementations, interactive tool 116 is executed at electronic device 110 and communicates with server 130 to perform the operations described herein. In other implementations, interactive tool 116 is executed at server 130, and electronic device 110 accesses interactive tool 116 by communicating with server 130.

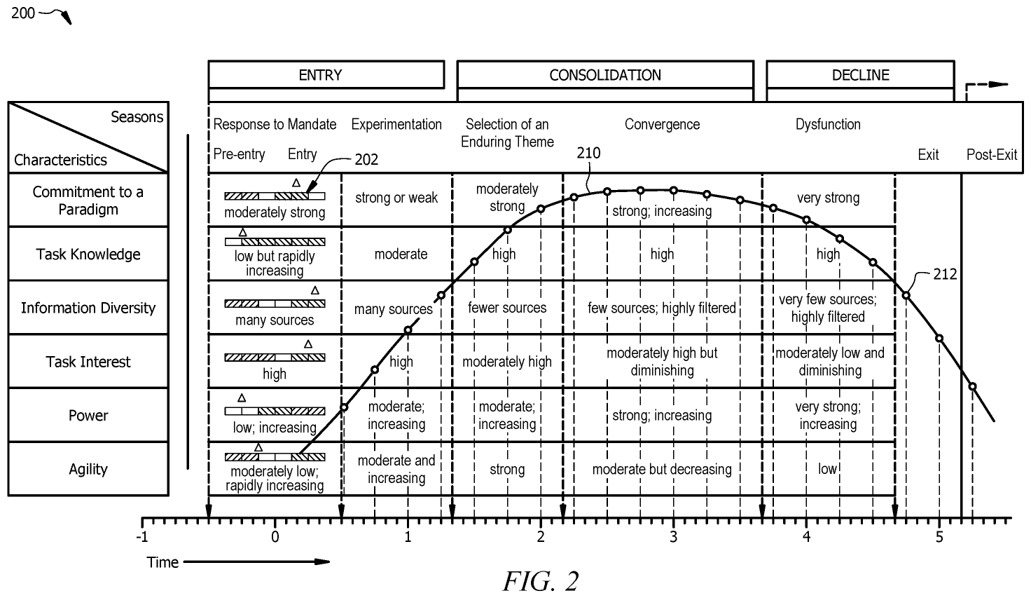

Additionally, electronic device 110 may include components for communicating with server 130 via network 120. For example, electronic device 110 may include a network adapter, which may be a wired or wireless adapter. Additionally, or alternatively, electronic device 110 may include a transmitter, a receiver, or a combination thereof (e.g., a transceiver) configured to transmit and/or receive data via network 120 (e.g., from server 130). Electronic device 110 may also include a user interface, such as a keyboard, a touch screen, a voice command system, a gesture-based input system, etc., for receiving user input. Electronic device 110 may also include a display device configured to display one or more graphical user interfaces (GUIs), as further described with reference to FIGS. 2-11.

Network 120, such as a communication network, may facilitate communication of data between electronic device 110 and other components, servers/processors, and/or devices. For example, network 120 may also facilitate communication of data between electronic device 110 and server 130. Network 120 may include a wired network, a wireless network, or a combination thereof. For example, network 120 may include any type of communications network, such as a direct PC-to-PC connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate.

Server 130 includes one or more processors 132 and a memory 134. One or more processors 132 may include a CPU, a GPU, and/or a microcontroller that performs the operations described herein. Memory 134 may include a ROM, a RAM, one or more HDDs, flash memory devices, SSDs, other devices configured to store data in a persistent or non-persistent state, a combination of different memory devices, or a combination thereof, configured to store the information described herein. For example, memory 134 may store instructions that are executed by one or more processors 132 to cause server 130 to perform the operations described herein.

Memory 134 may also store candidate data 136. Alternatively, candidate data 136 may be accessible to server 130 (e.g., at a remote storage device) or received from another device. Candidate data 136 includes information about a chief executive operator (CEO), such as information about the CEO at a previous job. Memory 134 may also store a predictive analytics engine 138. Predictive analytics engine 138 may be executed by one or more processors 132 to process a plurality of performance metrics 142 to produce one or more predictive performance metrics 144, as further described herein. As further described herein, predictive analytics engine 138 may be initialized based on at least a portion of candidate data 136 and a conceptual performance model 140 representative of an expected performance over a period of time. In some implementations, predictive analytics engine 138 includes a predictive analytics engine module that includes one or more routines, executable by one or more processors (e.g., the processor 132) to enable processing of performance metrics 142 to produce predictive performance metrics 144, as described herein

Memory 134 may store performance metrics 142 and predictive performance metrics 144. In a particular implementation, performance metrics 142 include hard key performance indicators (KPIs), soft KPIs, ratings, coefficient values, or a combination thereof. Memory 134 may also store processing rules 146 and pre-check rules 148. Processing rules 146 may include one or more rules for processing performance metrics 142, and pre-check rules 148 may include one or more rules for performing pre-checks before processing one or more of performance metrics 142. In some implementations, memory 134 may also store interactive tool 116, which may be executed by one or more processors 132 and may communicate with electronic device 110.

Additionally, server 130 may include components for communicating with electronic device 110 via network 120. For example, server 130 may include a network adapter, which may be a wired or wireless adapter. Additionally, or alternatively, server 130 may include a transmitter, a receiver, or a combination thereof (e.g., a transceiver) configured to transmit and/or receive data via network 120 (e.g., from electronic device 110). In some implementations, server 130 may also include a user interface, such as a keyboard, a touch screen, a voice command system, a gesture-based input system, etc., for receiving user input. In some implementations, server 130 may also include a display device configured to display one or more graphical user interfaces (GUIs), as further described with reference to FIGS. 2-11.

Predictive analytics engine 138 and interactive tool 116 are configured to process performance metrics 142 and to provide graphical displays of information that indicate the status of a CEO during his/her lifecycle with a company. In developing the current techniques, prior studies on CEO lifecycles are relevant. For example, prior studies have identified five trends or dimensions that are characteristically manifested across the CEO lifecycle: response to mandate—the ability to meet the expectations of the Board, and prove that the CEO was the right choice (e.g., demonstrating early efficacy); experimentation—characterized by intensive learning and trying out new approaches for leading the organization by establishing the “tone” of the tenure; selection of an enduring theme—using this tone, a specific paradigm or belief system is chosen about how the company should be run, described as “recrystallizing their paradigm,” it is a stage where their reflections are likely to be more subconscious than conscious; convergence—the CEO takes more incremental measures or actions to strengthen the selected route, CEOs generally hit their peak about halfway through this phase whereupon they plateau and gradually descend into the dysfunctional phase; dysfunction—while CEOs have reached a very strong power position, they simultaneously lack the excitement of the job, concentrating more on the “ceremonial” aspects of their job and more away from the peak performance standards of their convergence phase.

In conjunction with the five trends (e.g., “seasons”), prior studies have identified five dimensions that impact the life of a CEO over each phase or season: commitment to paradigm—CEO operates with a finite model of reality regarding how the environment behaves, what options are available to them, and how they believe the organization should be run; task knowledge—this is higher in the early stages of tenure, where there is a need to have a grasp of the facts, trends, contacts, and procedures from within the organization, and this is often easier from an internal appointment to grasp than from an external appointment; information diversity—the CEO's data behavior, this captures information from internal and external sources, and this becomes more focused and filed, with greater reliance on internal sources over time; task interest—the CEO's interest in the role, this is likely to diminish over time, the CEO becoming less responsive as routine and habit prevail, this is where the CEO transitions from curiosity to boredom, energized to fatigued, strategizing to habituation, and so on; power—once appointed there is the opportunity to enhance and solidify power, and over time this increases, such that over time, the CEO has the ability to co-opt the Board, re-configure the company in his/her image, and institutionalize his/her power.

The five seasons and the five dimensions (e.g., characteristics) have been tabulated below across the CEO's lifecycle to demonstrate how each of the phases and characteristics impacts the CEO and performance of the organization at different positions in time.

TABLE 1

| | | | Selection | | |
|---|---|---|---|---|---|
| | | | of an | | |
| CEO | Response | | Enduring | | |
| Characteristic | to Mandate | Experimentation | Theme | Convergence | Dysfunction |
| Commitment | Moderately | Could be strong | Moderately | Strong; | Very strong |
| to a Paradigm | strong | or weak | strong | increasing | |
| Task | Low but | Moderate; | High; | High; | High; |
| Knowledge | rapidly | somewhat | slightly | slightly | slightly |
| | increasing | increasing | increasing | increasing | increasing |
| Information | Many | Many sources | Fewer | Few sources; | Very few |
| Diversity | sources; | but increasingly | sources; | highly | sources; |
| | unfiltered | filtered | moderately | filtered | highly |
| | | | filtered | | filtered |
| Task Interest | High | High | Moderately | Moderately | Moderately |
| | | | high | high but | low and |
| | | | | diminishing | diminishing |
| Power | Low; | Moderate; | Moderate; | Strong; | Very strong; |
| | increasing | increasing | increasing | increasing | increasing |

As average CEO lifecycles have decreased from 10 years in the 1990s to approximately 5 years in the 2000 s. Some decrease may be due to 21st century leadership challenges, such as a fundamentally transformed leadership environment, struggles by organizations to adapt to the pace and change of the new environment, “datafication” and the rise of algorithms and “evidence-led” leadership, and escalating complexity that requires more responsive and accurate decision making. Some studies from the Harvard Business Review show that two in five CEOs fail within their first 18 months. Such trends have serious consequences for CEOs and Boards: the speed and intensity of change has increased the likelihood of poor performance, misalignment, and dysfunctional behavior; short and misaligned CEO tenure may result in decreased total shareholder returns (TSR) and sustainability, and long term tenure CEOs outperform short tenure CEOs with significantly higher TSR; and forced and early CEO termination often results in shareholder destruction, leadership instability, and reputational damage. Some research suggests that the optimal CEO tenure is seven years, thus, modern CEOs are not providing their full value.

Due to the decrease in CEO tenure, agility has emerged as a “stand-alone” leadership characteristic in the revised life-cycle model. Agility reflects the CEO's ability to swiftly adapt to change and the capability to recover from setbacks quickly, and includes skills such as foresight, tolerance for ambiguity, continuous renewal (learning and relearning), adaptability, and resilience. Agility creates the energy and space for a behavioral characteristic referred to herein as “reflaction” (e.g., a combination of reflection and action). Action with limited reflection can be a dangerous strategy often resulting in failure and disillusionment. Reflection with limited action results in inertia and an inadequate response to a change in stimulus. In the context of the present model, agility is a co-evolutionary process between the Board and CEO where the CEO is perceived as learning quickly from experience, and demonstrating a capability to adapt to changes in the business as well as with his/her key relationships with the Board. If these exchanges are not synchronized, divergences may arise, causing asynchronous relationships to develop that negatively impact the CEO, leadership team, and corporate performance.

The model derived from the previous research failed to account for the different levels of the corporation, for example to understand how the CEO operates through his/her exchanges with the Board and other key stakeholders. The model was a static interpretation that did not have a predictive capability. It did not provide an interactive predictive tool that could be used by the CEO or the Board in making decisions on CEO performance. In order to improve on the previous model, the model of the present disclosure focuses on the following aspects. The first aspect is greater definition on the macro and micro stages of the CEO lifecycle as well as significantly extending the scope of the CEO characteristics that are taken into account. For example, the following sub-stages have been added to the previous model: pre-entry in the Response to Mandate phase, peak contributions and plateauing sub-stages in the Convergence phase, and post-exit sub-stage in the Dysfunction stage as well as the addition of agility as a stand-alone characteristic. The second aspect is the integration of a conceptual performance model (e.g., a conceptual performance curve) which tracks the prototypical lifecycle of a CEO in-role and blends “hard” key performance indicator (KPI) data (e.g., financial and qualitative metrics) with “soft/qualitative” KPI data (e.g., that measures key characteristics of CEO behavior that are shaped through exchanges with the board across their tenure). The original model did not take into account the “rational” hard indicia that has sometimes been the key measure of a CEO's success or failure, thus, integrating hard and soft KPI data is preferable. The third aspect is that the integration of the hard and soft criteria is to be determined in near-real time (e.g., quasi-real time). For example, timing of decision nodes are matched to quarterly reporting requirements of publicly listed companies. These decision nodes capture the information in quasi-real time and provide data correlations and patterns that can be stored, analyzed, and used to re-synchronize executive performance and also provide predictions of probabilistic indicative causation over time. The fourth aspect is that the decision nodes use an algorithm engine (e.g., predictive analytics engine 138) which evaluates the quality, consistency, and responsivity (the QCR measure) of a Board decision(s). The model provides a contextual framework that exposes and clarifies the motivation level and cognitive biases of the Board (in essence, providing a form of choice architecture) when assessing the CEO's performance over their lifecycle.

The model described herein, referred to as the dynamic leadership algorithm model (DYLAM), is underpinned by an algorithm that provides the CEO and Board with a simple level of predictive capability based on probabilistic indicative causality (PIC) and provides a platform for the algorithm to guide the leadership team on their level of synchronization and for measuring the quality of the collective decisions made on the degree to which the CEO's values, attitudes, career intentions, etc., across time, mesh with those of the Board. The model includes an adjusted timeline that reflects the current global average lifecycle of five years. The model also provides flexibility, for example, sub-categories (criteria) can be defined under each characteristic that improves the model's ability to assess how synchronous the relationship between the CEO and the Board (and the broader organization) is at any point in the CEO lifecycle. The model described herein is a prototypical model. However, the model may be customized and adapted to the unique needs of an organization at a given point in time.

DYLAM includes a simple decision algorithm which diagnoses decision divergences between the Board and the CEO, and which captures insights into a CEO's and Board's decision typology; data that will be useful to the Board and CEO for managing their collective performance over the entire CEO life-cycle. The algorithm (as a by-product) also provides individual decision signatures for the CEO and Board; data that may be very valuable to any leadership advisory, or executive search firm. The purpose of the model and its algorithmic representation is to link CEO characteristics to the collective decision-making psychology of the Board, as organizations going through a change require a CEO whose personal identity (values and personality characteristics) are synchronized with or ‘fits’ the identity of the organization and the direction it takes. The Board's strategic objectives should to be aligned with the characteristics of the CEO (and vice-versa), where leaders are able to and willing to make and follow through on decisions that are in the best interests of the organization. The extent to which the leadership team are able to synchronize to produce these outcomes will set the potential limits of the leaders' ability to challenge and shape an organization's culture and to optimize the corporation's adaptability—to enable fast and effective responses to both internal and external challenges of its operation in the 21st century.

The QCR function in the DYLAM model is based on the assumption that cognitive biases and limitations, and complexity, prevent people from making optimal decisions despite their best intention and effort. Research in this field suggests that cognitive biases are not mutually exclusive and often occur in tandem. Thus, recognizing the distinction between cognitive biases is a good starting point. Table 2 below represents a subset of biases.

TABLE 2

| | | FRAMING OF | |
|---|---|---|---|
| | PERCEPTION | ALTERNATIVES | EQUILIBRIUM |
| EMOTION BIAS | BIAS | BIAS | BIAS |
| Excessive Optimism | Confirmation Bias | Framing | Status Quo |
| Overly estimate | Value evidence | The way a problem | Preference for status |
| positive outcomes | consistent with | is initially framed | quo. Resistance to |
| and underestimate | personal belief. | influences the way | change. |
| negative ones | Dismissive of | people think about | Present |
| Overconfidence | contradictory | the decision they | Value immediate |
| Overestimate our | evidence. Doesn't | make. When (+) | rewards highly and |
| skill relative to | search impartially | frame people are | under-value long |
| others as well as our | for evidence. | more conservative | term gains. |
| locus of control. | Anchoring | and risk averse. | |
| Take credit for | Decisions are linked | When (−) more | |
| positive past | strongly to initial | aggressive and | |
| performance and | value. | willing to accept | |
| minimize the role of | Groupthink | high risk. Frame can | |
| randomness or | Strive for consensus | be manipulated by | |
| chance. | of the cost of | leaders. | |
| Loss Aversion | realistic appraisal or | Escalation of | |
| Feel losses more | alternative course of | Commitments | |
| acutely than gains of | action. | Invest additional | |
| same amount. Make | Egocentrism | resources in a losing | |
| us more risk averse | Singular focus on | proposition due to | |
| than a rational | own perspective. | money, time, and | |
| calculation would | Ignore or blind to | effort already | |
| suggest. | impact to others. | invested. | |
| | Assume everyone | Sunk-cost Fallacy | |
| | has same access to | Emotionally connect | |
| | information. | to historical costs | |
| | Herd | that aren't | |
| | Lack of individual | recoverable when | |
| | decision making and | considering future | |
| | reflection. Members | action. | |
| | think and act in the | Controllability | |
| | same way as those | Belief that you can | |
| | around them. Fear | control outcomes | |
| | of missing out and | which can cause | |
| | mimicking rivals. | serious misjudgment | |
| | Innate pressure to | on risk. | |
| | conform. | | |

Re-positioning these biases into taxonomic groups makes it easier to navigate and upload these into a decision algorithm. Creating and placing this subset of cognitive biases into a data structure customized to reflect the key biases of CEO and Board decision-making itself a type of choice architecture that directs the CEO and Board to the most relevant areas (biases/motivation levels) that impact decision quality, consistency and responsivity (QCR). For the purposes of the algorithm, a subset of the taxonomic group outlined in Table 2 is used. However, these can be customized for each unique leadership team. The subset used would normally be determined by the results of cognitive bias assessment of a subject CEO and Board and the results of which would then be fed into the model as simple ‘pop-up’ menus that the Board and CEO have chosen.

The DYLAM model assists key decision makers to make better decisions by changing the framing and structure of choices in the decision-making environment. This is achieved through the provision of a QCR coefficient—which is a measure or index that reflects the degree to which the CEO and Board rate the quality of the decision by taking into account the cognitive biases and motivation of the decision maker(s). Setting good defaults is important when emotions such as happiness or anger reduce the depth of cognitive processing. DYLAM helps frame and structure choices for CEOs and Board joint decision making at each decision node (DN) and better frame the decision matrix by putting a spotlight on potential blind spots and negative emotion. The dynamic function of DYLAM allows both CEOs and Boards to ensure their decision-making matrix is better aligned with changing organizational, situational and personality changes that occur over a CEO's life-cycle. In this regard, the DYLAM model provides a de-biasing function that allows CEOs and Boards to anticipate and control biases by nudging them in the right direction. Targeted behavioural nudges in DYLAM can be designed and optimized to invoke the CEO and Board's “desire” to be better leaders.

In order to develop an algorithmic CEO Life-Cycle model, objectification and datification of the characteristics of the CEO Life-Cycle model is performed. This uses a numeric and logical translation of the CEO characteristics as well an algorithm that makes sense of the data. The DYLAM model uses a 1 to 7 rating system for the following reasons: firstly it has been a well tried and proven academic grading system implemented by top universities around the world in order to effectively group and compare student performance; secondly, as often suggested in various psychometric literatures, a 7 point rating system (1 being the weakest and 7 the strongest) allows for a variety of options for discrimination yet not too many that the system becomes incomprehensible.

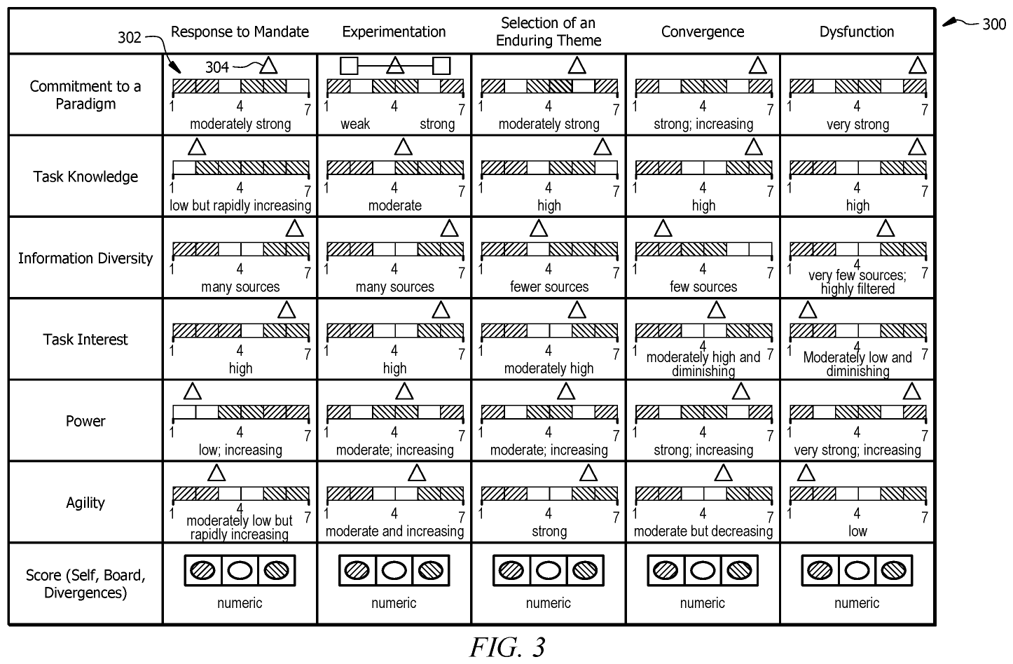

Next, a scale for each characteristic and then plot of the prior research findings with markers (e.g., triangles and squares) which can reflect the distinct “standardized” patterns that generally occur during a CEO's tenure (the normative data) is generated. A higher numeric score does not necessarily represent a more positive value in the plot. To properly reflect the relative importance of each characteristic in each phase of the CEO's lifecycle, the “ideal” position is color coded in each phase relative to the “norm” in order to highlight an optimum position versus the standardized benchmark position in each phase of the CEO's lifecycle. This information can be viewed via a GUI, as described with reference to FIG. 3. In a particular implementation, green equates to good/above benchmark, yellow equates to average/acceptable performance (meets benchmark), and red equates to poor/below benchmark performance. Movement from the “norm” (e.g., a triangle) to an “ideal” (e.g., green marker) position will likely result in higher productivity and tenure in the role.

This relative assessment is important to the model as it allows the Board and CEO to discuss and adjust the relative “ideal” position to better reflect the industry dynamic and specific needs of the corporation. It also provides a flexible and more objective basis for determining, synchronizing and managing “emotional” fit with the CEO and Board as these characteristics and assessment can be customized.

For the model to be useful it has to capture and process changes in the phases and with the CEO and Board in “real-time” as close as is practical. The algorithm needs to assess the interrelationships and inter-connectedness of these constructs in an iteratively meaningful and regular way over time. The corporation and the CEO need to be able to monitor and evaluate their degree of integration, the extent to which their values matrix and corporate CEO's “personality” is synchronous, at multiple decision nodes over CEO's lifecycle with the company, to enable a more rapid and effective response by the company to the multivariable and unpredictable factors that may impact upon the company's internal and external operating environment across the CEO's tenure.

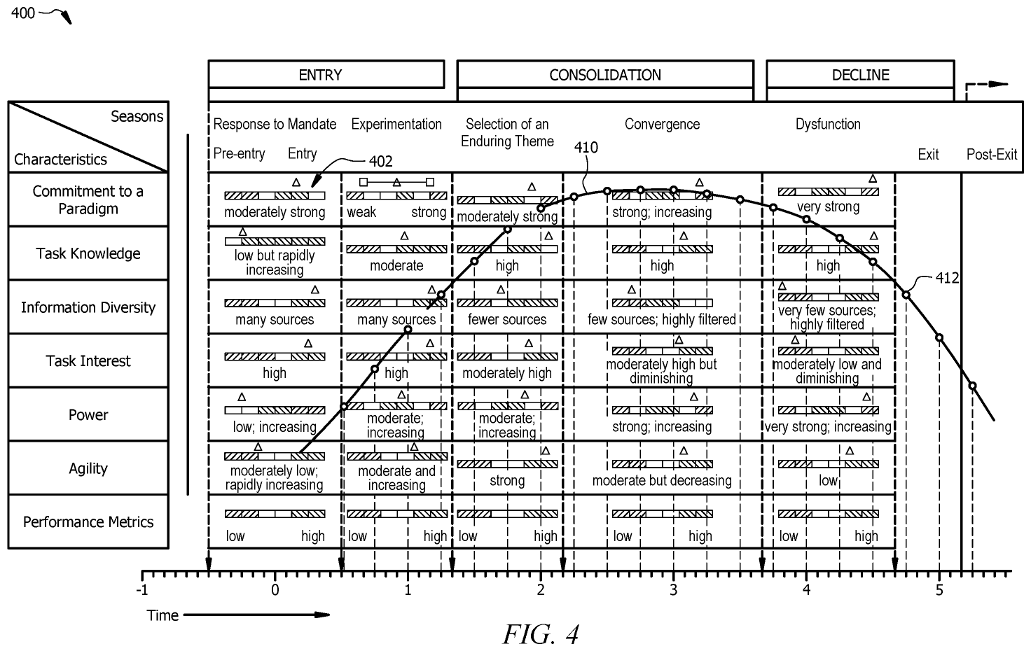

A combination of the conceptual curve and the plot is described with reference to FIG. 4. The dots in the diagram represent decision nodes. The timing of the decision nodes link to the compliance requirements for quarterly board meetings for publicly listed corporations. The timing provides sufficient time for remedial action in the event of asynchronous behavior between the CEO and the Board. The decision nodes may capture the information in quasi-real time and provide data correlations and patterns that can be stored, analyzed, and used to re-synchronize executive performance, as well as providing predictions of probabilistic indicative causation over time.

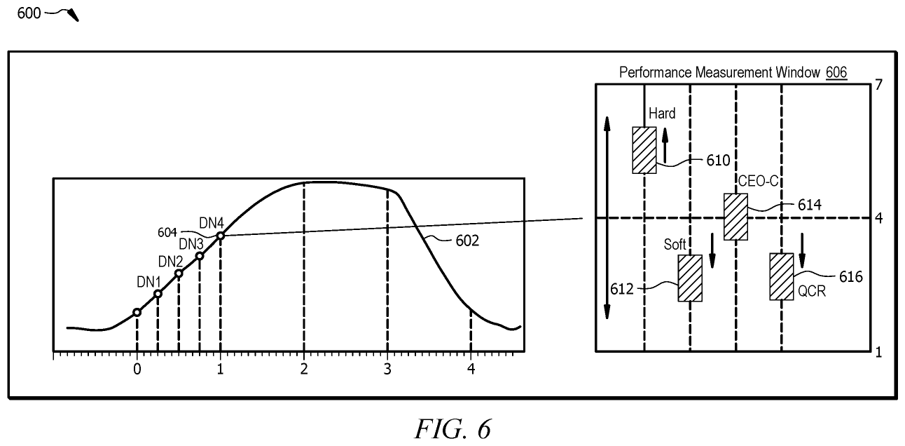

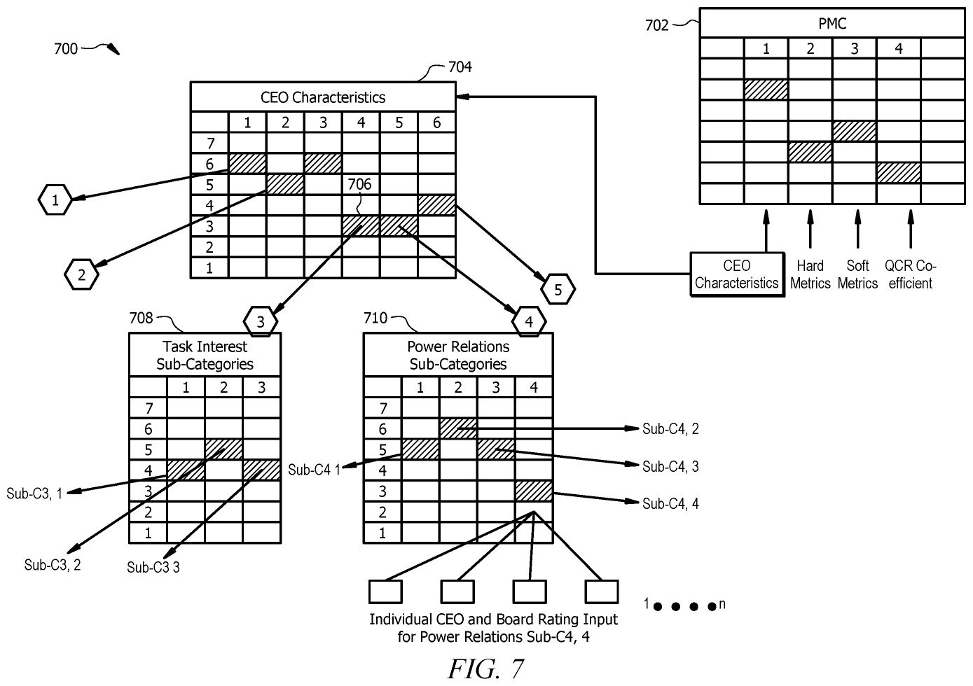

In some implementations, each decision node may be selected to view the information underlying the decision node, as described with reference to FIG. 6. For example, a performance measurement window may be displayed that shows the relationship between the underlying performance metrics (e.g., hard KPIs, soft KPIs, CEO characteristics (CEO-C), and Q-Score) and the conceptual performance curve. Additional sub-category windows can be displayed, as further described with reference to FIG. 7.

In addition to graphically providing the information, the model integrates hard KPIs (also referred to as hard performance metrics) that are generally used to assess CEO performance. The performance metrics are composed of two KPI categories which are: (i) quantitative metrics (market related data or facts); and (ii) qualitative measures (based on internal and external measurements of attitudes or opinions). There are hundreds of KPIs to choose from and organizations often struggle to select the appropriate ones for their business. KPIs are designed to measure how successfully the organization achieves its objectives and goals. The CEO, The Board and the Executive/Management Team generally identify a set of questions that are critical to the business, and then implement the KPIs that help answer these critical questions. In a particular implementation, the QCR measure is only be applied to the soft characteristics (CEO Characteristics). In other implementations, the QCR measure applies to hard metrics as well.

Any number of KPIs can be used in the DYLAM model, for example based on a user selection. In a particular implementation, ten KPIs are used: revenue, return on asset, earnings before interest, taxes, depreciation, and amortization (EBITDA), growth rate, total shareholder return, revenue per employee, actual vs. forecast revenue, employee engagement, external shareholder, and customer satisfaction. In other implementations, other KPIs are used.

The DYLAM algorithm has been designed to provide a flexible methodology that allows the CEO and Board to individually and jointly determine the CEO's performance/behavior by assigning a 1-7 rating towards various characteristics at a periodic interval (usually quarterly, although not limited to such), which allows for consistent monitoring and provides the foundation for dynamic adjustments going forward. For the Board's assessment, built into the algorithm is the Decision Divergence Rule (DDR) which, in a particular implementation, takes the average of the top 2 and the bottom 2 ratings of the Board and requires the differential to fall within a specified range (e.g., satisfy one or more thresholds)—the purpose of the DDR is to synchronize individual board member assessment within a certain range to ensure that the group reaches a decision collectively yet retaining “individuality” in assessing the CEO's performance at the same time. The DDR is designed to decrease the effect that one individual outlier rating could have on setting the general alignment of the board and hence being more efficient with the Board's time. Secondly, by requiring the difference between the two averages to be within 3 means, then the overall range of board member ratings are limited to roughly 40%, hence providing room for different opinions while maintaining a general consensus. If the Board members' ratings do not meet the requirement, the model will trigger a decision divergence alert and call for a reassessment. For example, an indicator may appear on the display indicating that the difference failed to satisfy the thresholds, and/or messages to the Board members requesting reconsidered ratings may be transmitted. In some implementations, in response to the reconsidered ratings failing to satisfy the thresholds, an average for the original ratings is used. In other implementations, messages for reassessments may be retransmitted until the ratings satisfy the thresholds.

After the ratings are taken, an average of all the individual Board members' assessment is then taken to result in an average board rating for each characteristic. The rating calculated for each characteristic may be converted into colored indicators (e.g., by interactive tool 116). In a particular implementation, the colors are red, yellow, and green to indicate below benchmark, achieving benchmark, and above benchmark, respectively. The conversion result of a particular rating is dependent on the “ideal” situation for that particular characteristic at that particular CEO lifecycle phase. For example, a 7 rating might not represent an ideal situation (green) or similarly, a rating that produces a green color indicator during the Experimentation phase may not produce the same color indicator during the Convergence phase. In a particular implementation, the rating-color indicator conversion rule (e.g., of processing rules 146) may be preset. However, in some implementations, the rules may be modified based on user input to enable the Board to modify the rules to their own strategy or particular industry characteristics. Additionally, or alternatively, specific weightings for the CEO characteristics can be individually determined and adjusted dynamically to reflect the priorities of the CEO during a particular lifecycle phase.

After the ratings are determined, an aggregated rating and color indicator may be determined (both from the Board's assessments and the CEO's self-assessment) to indicate the overall performance of the CEO in the Board's view as well as the CEO's own view. A QCR coefficient may also be calculated at each decision node by the Board. The coefficient is to let the Board reflect on the various cognitive biases that could affect their decision-making quality. The QCR coefficient is also incorporated into the aggregate rating and color indicators to allow for visual representation and tracking of the Board's decision-making quality over time on the conceptual performance curve. The Board and CEO's assessments may then be combined into a final aggregate rating and color code to present a single clear outcome for monitoring purposes.

In some implementations, pre-check decision rules (e.g., 148) are accessed to ensure that the Board and CEO's overall consensus are aligned and if not, then a discussion is initiated (e.g., a pop-up may appear on the display or messages may be transmitted to the CEO and the Board members). In a particular implementation, the pre-check decision rule requires that the Board and the CEO's color indicators (for each characteristic) to not be on the opposite end of the scale (e.g., red vs. green) as well as the difference between their overall weighted average outcomes be within a 15% differential. In other implementations, the pre-check decision rule may require other differentials.

After the aggregate ratings are determined, individual specific weightings for both hard and soft metrics as well as their corresponding categories can all be adjusted dynamically to reflect the priorities of the CEO during a particular lifecycle phase. A weighted average may be calculated for each category which may then be converted into an equivalent rating on the 1-7 rating scale resulting in a numeric and descriptive score of the CEO's performance against the different criteria. Finally, a total weighted average score of all the categories may be calculated resulting in a total rating for plotting on the curve of the CEO lifecycle.

To further illustrate, the process is described. For every individual characteristic (i), each board member (j) provides a 1 to 7 rating assessment (x_{i,j,t}), which is then taken as input to calculate an aggregate board rating (x_{Board,i,t}) as well as provide a visual colour indicator (Colour_{Board}) and reflective score (Score_{Board}).

For calculating the aggregate board rating, an average calculation is used. However, while it is understandable that each Board member might have a slightly different assessment on a CEO's characteristic, to ensure that the assessment from the Board as a whole is in general alignment, a pre-check decision rule (e.g., 148) is implemented. In a particular implementation, this decision rule, namely the Decision Divergence Rule, is the following:
If for each i, average of top 2 x_{Board,i,j,t}−average of bottom 2 x_{Board,i,j,t}≥3, Then discussion needed for board members before proceeding.

The Decision Divergence Rule has been constructed as such to incorporate 2 factors: firstly, by taking the average of the top 2 and bottom 2 ratings as opposed to the highest and lowest rating, the effect that one individual outlier rating could have on setting the general alignment of the board is reduced and hence it is more efficient with the Board's time. Secondly, by requiring the difference between those 2 averages to be within 3 means that the overall range of board member ratings are limited to roughly 40%, hence providing room for different opinions while maintaining a general consensus. As stated by the rule, if the Board members' ratings don't meet that requirement, then a discussion is scheduled about reassessment. For example, messages to the Board members may be transmitted to indicate that reassessment is to take place. And in the event of non-agreement (e.g., based on the reassessment), an average is taken for their original assessments to provide an aggregate board rating.

Once the aggregate board rating is calculated, it is then compared against the relevant colour indicator ranges (R_{i,t}, Y_{i,t}, G_{i,t}) for that characteristic at time t (as shown in FIG. 3). In order to quantify each colour indicator as well as incorporate the relative importance of each characteristic at time t, in a particular implementation for each Red indicator a value (y_{Board,i,t}) of 0 is assigned, each Yellow a value (y_{Board,i,t}) of 4/7 is assigned, and each Green a value (y_{Board,i,t}) of 1 is assigned. Subsequently a characteristic weight (w_{i,t}) is also applied to each characteristic outcome and a weighted average is calculated (Σᵢ₌₁ⁿw_{i,t}y_{Board,i,t}). It should be noted that in the interest of consistency a Yellow is given the value of 4/7 since a 4 is representative of the average on the 1 to 7 rating scale.

A decision rule (e.g., 146) used to convert this weighted average outcome to an aggregate color indicator (Color_{Board}) is flexible and can be changed based on user input. In a particular implementation, a default setting is set such that: if the weighted average outcome is below (1−3*min wᵢ), then an aggregate Red is given, if the weighted average outcome is above (1−3*min wᵢ) but below (1−2*min wᵢ), then an aggregate Yellow is given, and if the weighted average outcome is above (1−2*min wᵢ), then an aggregate Green is given.

The idea behind the default ranges is—if the CEO scores 3 Reds for the least important characteristic then it is equivalent to an aggregate Red; anything between 3 and 2 Reds for the least important characteristic is equivalent to an aggregate Yellow; and anything above 2 Reds for the least important characteristic is equivalent to an aggregate Green. It should be noted that the benefits of applying weights to different characteristics becomes obvious when applying this decision rule—in the event that the CEO obtains a Red or Yellow for a more highly weighted characteristic, the aggregate color indicator would be able to accurately pick it up and result in a Red/Yellow even though all other characteristics might obtain a Green color indicator. Finally, to present the board with an aggregate numeric score (Score_{Board,t}) in conjunction with the aggregate color indicator (Color_{Board,t}), the weighted average outcome (Σᵢ₌₁ⁿ=w_{i,t}y_{Board,i,t}) is multiplied by 7.

In some implementations, in order for the Board to reflect upon the quality of the ratings that they have given for each characteristic and to systematically require each member to be aware of the existence as well as ideally combat the effects of various cognitive biases, the QCR coefficient is used. The purpose of this coefficient is to: (i) put in place, as part of the framework, a process that requires each board member to reflect and comment on their degrees of awareness of the various biases involved during their decision-making process and to ultimately assist them in judging the quality of their decisions; and (ii) by incorporating this coefficient into the aggregate numeric rating score (Score_{Board,t}) and plotting it against each decision node on the conceptual performance curve, the Board is then able to visually see the effects that these biases have on their decisions and track their progress in improving their rating qualities over time. For example, surveys given to the CEO and the Board for the ratings may also include a cognitive bias and motivation survey, that can be correlated with a QCR survey. In some implementations, pop-up windows may provide information identifying and explaining each type of cognitive bias the Board is asked to reflect on and clearly defining metrics to ensure consistent assessment, which is designed to improve the meta cognitive competences of the Board. The system may provide targeted behavioural nudges to invoke the CEO and Board's ‘desire’ to be better leaders and assist them in generating better decision outcomes.

In a particular implementation, the QCR coefficient at each decision node is determined through the following process: at the end of each meeting, for example after a reflection period, each Board member is asked (e.g., via a survey provided by the system to mobile devices or other electronic devices of each Board member) whether or not they felt they were actively aware of the various biases that could exist and made their decision in light of that and provide a “yes” or “no” answer. For example, the system may display a list or table of cognitive biases, decisions the biases are related to, and an input button for the “yes” or “no” answer from the Board member. In some implementations, if the Board member selects a “no” answer, the system may request that the Board member input a 1-2 sentence description of which biases they perceived and how those biases impacted decisions. Additionally or alternatively, one or more graphic indicators may be displayed to represent the Board member's answers, how the answers impact determination of the QCR coefficients, and how the QCR coefficients impact the overall ratings provided by the Board member. The number of “no” answers (Noₜ) are recorded. If less than or equal to 25% (or between 0-30%) of the Board members gave a “no” answer, then the QCR coefficient is set equal to 0. If more than 25% and less than 50% (or 30-50%) of the Board members gave a “no” answer, then the QCR coefficient is set equal to the negative of half of the minimum characteristic weight used at that particular decision node times

$$7 ( - \frac{min {w}_{i , t}}{2} * 7 ) .$$

If more than or equal to 50% of the Board members gave a “no” answer, then the QCR coefficient is set equal to the negative of the minimum characteristic weight used at that particular decision node times 7 (−min w_{i,t}*7). After determining the QCR coefficient, the QCR coefficient is added onto the aggregate numeric rating score (Score_{Board,t}) and provides an adjusted aggregate numeric rating score denoted as the Q-Score (Q−Score_{Board,t}) as well as an adjusted aggregate color indicator denoted as Q−Colour_{Board,t} to present a clear outcome for monitoring purposes.

In the particular implementation, reasoning for selection of the above QCR values follows. Firstly, in the case that a decent majority of the Board believe high quality decisions are made (as represented by 25% or less of the Board members giving a “no” response), then the original aggregate numeric score is already a good reflection of the Board's true assessment and should not be adjusted. In the case that a small portion of the Board believes that high quality decisions have not been made (as represented by more than 25% and less than half of the Board members giving a “no” response), then half of the minimum characteristic weight times 7 will be taken off the aggregate numeric rating. This value is chosen because given the aggregate colour indicator is determined using units of the minimum characteristic weight under the default setting, so, by taking away half of that weight it would represent an acknowledgement that some Board members believe the quality of the assessments have not been great, yet at the same time not letting that belief adjust either the aggregate rating or colour indicator too significantly given it's still not a majority belief. The value is then multiplied by 7 as a matter of consistency with the calculation of the aggregate numeric rating and allowing the QCR coefficient to be added to it. In the case that a large portion of the Board believes that high quality decisions have not been made (as represented by more than or equal to half of the board members giving a “no” response), then the minimum characteristic weight times 7 is taken off the aggregate numeric rating. This value is chosen for similar reasoning to the above, however, this time making a more significant adjustment due to the larger portion of the Board believing in the low decision qualities. It is likely that this adjustment causes the aggregate colour indicator to change from either a Green to a Yellow or a Yellow to a Red.

It should also be noted that while the QCR coefficient is calculated to reflect and subsequently help improve on the quality of the Board's decisions at each decision node, there is also an opportunity to use the QCR coefficient, in conjunction with other data points obtained, to analyze patterns over time and provide insights into the Board's decision making process/quality that would subsequently have implications on the Board's overall effectiveness. For example, these data driven insights may provide a valuable foundation for a periodic Board effectiveness discussion. As a particular example, a Chairman of the Board may use the QCR coefficient (e.g., the results of the cognitive bias questions from the other members of the Board), to perform actions with respect to the Board, the CEO, the organization, or a combination thereof. To illustrate, if the QCR coefficient indicates that 25 or 30-50% of the Board members do not believe that quality decisions have been made (e.g., in view of the cognitive biases described in the survey), the Chairman may begin the next Board meeting with a discussion of cognitive biases and how the biases are affecting the decisions made by the organization. As another example, if the QCR coefficient indicates that more than 50% of the Board members do not believe that quality decisions have been made, the Chairman may reconvene the Board to continue a decision-making process at the particular Board meeting. Additionally or alternatively, the Chairman may use the QCR data, or the system may provide textual or graphic items, that indicate patterns in biases over time, relationships between recorded biases and decisions made by the Board, the CEO, or the actions of the organization at common times, as well as displaying trends related to biases to provide estimates for future biases and the relationships of those biases to future decisions and actions.

The following formulas are used in determining the above-described values.

$${x}_{Board , i , t} = \frac{{\sum }_{j = 1}^{n} {x}_{i , j , t}}{n} \qquad Formula 1$$

$${y}_{Board , i , t} = \{ \begin{matrix}0 , {x}_{Board , i , t} ∈ {R}_{i , t} \\ \frac{4}{7} , {x}_{Board , i , t} ∈ {Y}_{i , t} \\ 1 , {x}_{Board , i , t} ∈ {G}_{i , t}\end{matrix} \qquad Formula 2$$

$$If \{ \begin{matrix}{\sum }_{i = 1}^{n} {w}_{i , t} {y}_{Board , i , t} < ( 1 - 3 * min {w}_{i} ) \\ ( 1 - 3 * min {w}_{i} ) \leq {\sum }_{i = 1}^{n} {w}_{i , t} {y}_{Board , i , t} < ( 1 - 2 * min {w}_{i} ) \\ ( 1 - 2 * min {w}_{i} ) \leq {\sum }_{i = 1}^{n} {w}_{i , t} {y}_{Board , i , t}\end{matrix} , Then \{ \begin{matrix}{Color}_{Board , t} = Red \\ {Color}_{Board , t} = Yellow \\ {Color}_{Board , t} = Green\end{matrix} \qquad Formula 3$$

$${Score}_{Board} = {\sum }_{i = 1}^{n} {w}_{i , t} {y}_{Board , i , t} * 7 \qquad Formula 4$$

$$If \{ \begin{matrix}{No}_{t} \geq 0.5 * n \\ 0.5 * n > {No}_{t} > 0.25 * n \\ 0.25 * n \geq {No}_{t}\end{matrix} , Then \{ \begin{matrix}{QCR}_{t} = - min {w}_{i , t} * 7 \\ {QCR}_{t} = - \frac{min {w}_{i , t}}{2} * 7 \\ {QCR}_{t} = 0\end{matrix} \qquad Formula 5$$

$$Q - {Score}_{Board , t} = {Score}_{Board , t} + {QCR}_{t} \qquad Formula 6$$

$$If \{ \begin{matrix}Q - {Score}_{Board , t} < ( 1 - 3 * min {w}_{i , t} ) * 7 \\ ( 1 - 3 * min {w}_{i , t} ) * 7 \leq Q - {Score}_{Board , t} < ( 1 - 2 * min {w}_{i , t} ) * 7 \\ ( 1 - 2 * min {w}_{i , t} ) * 7 \leq Q - {Score}_{Board , t}\end{matrix} , Then \{ \begin{matrix}Q - {Color}_{Board , t} = Red \\ Q - {Color}_{Board , t} = Yellow \\ Q - {Color}_{Board , t} = Green\end{matrix} \qquad Formula 7$$

In Formulas 1-7, w_{i,t}=Characteristic weights at period t and Σᵢ₌₁ⁿw_{i,t}=1 for each t and n is a positive real number (e.g., sum of the weights is equal to 1).

The following is an example to illustrate the calculations associated with formulas 1-7. The performance metrics (e.g., Board member ratings for Commitment to Paradigm, Task Knowledge, Information Diversity, Task Interest, Power, and Agility) are received and processed to determine the aggregate ratings and the QCR influenced ratings. Values for the particular ratings and determined values are given in Table 3 and Table 4. These values represent one particular example, and are not limiting.

TABLE 3

| | | | | | | | | | | Average | Individual | Aggregate | Aggregate |
|---|---|---|---|---|---|---|---|---|---|---|---|---|---|
| Characteristic | Weights | Board Rating | | | | | | | | Rating | Color | Color | Rating |
| (i) | (w_{i, t}) | (x_{Board, i, j, t}) | | | | | | | | (x_{Board, i, t}) | (y_{Board, i, t}) | (Color_{Board, t}) | (Score_{Board, t}) |
| Commitment | 0.3 | 4 | 5 | 5 | 5 | 4 | 6 | 6 | 4 | 4.875 | G (1) | G | 6.55 |
| to Paradigm | | | | | | | | | | | | | |
| Task | 0.2 | 3 | 5 | 5 | 4 | 4 | 3 | 4 | 4 | 4 | G (1) | | |
| Knowledge | | | | | | | | | | | | | |
| Information | 0.2 | 5 | 6 | 7 | 7 | 6 | 5 | 6 | 5 | 5.875 | G (1) | | |
| Diversity | | | | | | | | | | | | | |
| Task Interest | 0.15 | 5 | 5 | 5 | 5 | 4 | 6 | 5 | 4 | 4.875 | Y ( 4/7) | | |
| Power | 0.1 | 4 | 4 | 3 | 4 | 5 | 5 | 3 | 4 | 4 | G (1) | | |
| Agility | 0.05 | 5 | 5 | 5 | 6 | 6 | 6 | 5 | 5 | 5.375 | G (1) | | |

TABLE 4

| | | | Adjusted |
|---|---|---|---|
| | | Adjusted | Aggregate |
| Number of “No” | QCR | Aggregate | Rating |
| responses | coefficient | Color | (Q − |
| (Noₜ) | (QCRₜ) | (Q − Color_{Board, t}) | Score_{Board, t}) |
| 3 | −0.35 | G | 6.2 |

The average rating for the Board is determined by computing the average of each Board rating. For example, x_{Board,1,t}=(4+5+5+5+4+6+6+4)/8=4.875. As another example, x_{Board,2,t}=(3+5+5+4+4+3+4+4)/8=4. Similarly, x_{Board,3,t}=5.875, x_{Board,4,t}=4.875, x_{Board,5,t}=4, and x_{Board,6,t}=5.375. The corresponding color ranges are determined based on time t. In this example, G_{1,t}={4, 5}, G_{2,t}={2, 3, 4, 5, 6, 7}, G_{3,t}={5, 6, 7}, Y_{4,t}={4}, G_{5,t}={3, 4}, and G_{6,t}={5, 6, 7}. Therefore, the corresponding values used for subsequent calculations are y_{Board,1,t}=1, y_{Board,2,t}=1, y_{Board,3,t}=1, y_{Board,4,t}= 4/7, y_{Board,5,t}=1, and y_{Board,6,t}=1.

Next, the weighted average of the characteristics' color outcome is taken. Σᵢ₌₁⁵w_{i,t}y_{Board,i,t}=0.3+0.2+0.2+0.15* 4/7+0.15=0.94. Since the weighted average is above the following predetermined bound, Σᵢ₌₁⁵w_{i,t}y_{Board,i,t}≥1−2*0.15, then Color_{Board,t}=Green. The Board's aggregate rating is determined by multiplying the weighted average by 7: Score_{Board,t}=Σᵢ₌₁⁵w_{i,t}y_{i,t}*7=0.94*7=6.55. Because the number of “no's” Noₜ=3, which is greater than 25%, the QCR coefficient is given by

$${QCR}_{t} = - \frac{min {w}_{i}}{2} * 7 = - \frac{0.01}{2} * 7 = - 0.35 .$$

Thus, Q−Score_{Board,t}=Score_{Board,t}+QCRₜ=6.55+(−0.35)=6.2. Finally, because (1−2*min w_{i,t})*7=(1−2*0.1)*7≤Q−Score_{Board,t}, then Q−Color_{Board,t}=Green.

In addition to processing ratings from the Board, DYLAM also provides for processing of CEO self-reported ratings. For the CEO self-reported rating the same methodology may be employed as above in the Board calculation. To illustrate, for every individual characteristic (i), the CEO provides a 1 to 7 rating assessment (x_{CEO,i,t}), and the model also provides a visual color indicator (Color_{CEO}) and reflective score (Score_{CEO}).

Each characteristic rating is then compared against the relevant colour indicator ranges (R_{i,t}, Y_{i,t}, G_{i,t}) for that characteristic at time t (corresponding time phase) as shown in the Characteristic Indicator Colour Chart attached below, outputting a corresponding (y_{CEO,i,t}) which is then applied with the characteristic weight (w_{i,t}) to calculate a weighted average outcome (Σᵢ₌₁ⁿ w_{i,t}y_{CEO,i,t}).

In a particular implementation, the default decision rule (e.g., 146) used to convert the weighted average outcome to an aggregate color indicators (Color_{CEO}) is the same as used in the case of the Board. To illustrate, if the weighted average outcome is below (1−3*min wᵢ), then an aggregate Red is assigned, if the weighted average outcome is above (1−3*min wᵢ) but below (1−2*min wᵢ), then an aggregate Yellow is assigned, and If the weighted average outcome is above (1−2*min wᵢ), then an aggregate Green is assigned. As before, if min wᵢ<0.1, then substitute min wᵢ with second lowest wᵢ in the above calculations. Finally, to calculate an aggregate score (Score_{CEO}), the weighted average outcome (Σᵢ₌₁ⁿ w_{i,t}y_{CEO,i,t}) is multiplied by 7. In some implementations, a QCR coefficient is not included for CEO reported characteristics. In other implementations, the QCR coefficient may be included.

The following formulas are used in determining the above-described values.

$${y}_{CEO , i , t} = \{ \begin{matrix}0 , {x}_{CEO , i , t} ∈ {R}_{i , t} \\ \frac{4}{7} , {x}_{CEO , i , t} ∈ {Y}_{i , t} \\ 1 , {x}_{CEO , i , t} ∈ {G}_{i , t}\end{matrix} \qquad Formula 8$$

$$If \{ \begin{matrix}{\sum }_{i = 1}^{n} {w}_{i , t} {y}_{CEO , i , t} < ( 1 - 3 * min {w}_{i} ) \\ ( 1 - 3 * min {w}_{i} ) \leq {\sum }_{i = 1}^{n} {w}_{i , t} {y}_{CEO , i , t} < ( 1 - 2 * min {w}_{i} ) \\ ( 1 - 2 * min {w}_{i} ) \leq {\sum }_{i = 1}^{n} {w}_{i , t} {y}_{CEO , i , t}\end{matrix} , Then \{ \begin{matrix}{Color}_{CEO , t} = Red \\ {Color}_{CEO , t} = Yellow \\ {Color}_{CEO , t} = Green\end{matrix} \qquad Formula 9$$

$${Score}_{CEO} = {\sum }_{i = 1}^{n} {w}_{i , t} {y}_{CEO , i , t} * 7 \qquad Formula 10$$

The following is an example to illustrate the calculations associated with formulas 8-10. The performance metrics (e.g., CEO ratings for Commitment to Paradigm, Task Knowledge, Information Diversity, Task Interest, Power, and Agility) are received and processed to determine the aggregate ratings and the color values. Values for the particular ratings and determined values are given in Table 5. These values represent one particular example, and are not limiting.

TABLE 5

| | | | Individual | Aggregate | Aggregate |
|---|---|---|---|---|---|
| Characteristic | Weights | CEO | Color | Color | Rating |
| (i) | (w_{i, t}) | Rating (x_{i, t}) | (y_{i, t}) | (Color_{CEO, t}) | (Score_{CEO, t}) |
| Commitment | 0.3 | 3 | Y ( 4/7) | G | 6.1 |
| to Paradigm | | | | | |
| Task | 0.2 | 6 | G (1) | | |
| Knowledge | | | | | |
| Information | 0.2 | 5 | G (1) | | |
| Diversity | | | | | |
| Task Interest | 0.15 | 7 | G (1) | | |
| Power | 0.1 | 4 | G (1) | | |
| Agility | 0.05 | 6 | G (1) | | |

The corresponding color ranges are determined based on time t. In this example, Y_{1,t}={3, 6, 7}, G_{2,t}={2, 3, 4, 5, 6, 7}, G_{3,t}={5, 6, 7}, G_{4,t}={5, 6, 7}, G_{5,t}={3, 4}, and G_{6,t}={5, 6, 7}. Therefore, the corresponding values used for subsequent calculations are y_{CEO,1,t}= 4/7, y_{CEO,2,t}=1, Y_{CEO,3,t}=1, Y_{CEO,4,t}=1, Y_{CEO,5,t}=1, and y_{CEO,6,t}=1.

Next, the weighted average of the characteristics' color outcome is taken. Σᵢ₌₁⁵ w_{i,t}y_{CEO,i,t}=0.3* 4/7+0.2+0.2+0.15+0.15+=0.87. Since the weighted average is above the following predetermined bound, Σᵢ₌₁⁵ w_{i,t}y_{CEO,i,t}≥1−2*0.15, then Color_{CEO,t}=Green. The CEO's aggregate rating is determined by multiplying the weighted average by 7: Score_{CEO,t}=Σᵢ₌₁⁵ w_{i,t}y_{CEO,i,t}*7=0.87*7=6.1.

After determining the Board's aggregating rating and the CEO's rating, the ratings may be combined. For example, when combining the aggregate ratings of the CEO and Board to give an overall aggregate outcome (Aggregate Rating), an average is taken provided that the input satisfies certain pre-check decision rules (e.g., 148). In a particular implementation, these pre-check decision rules include the following two rules: first, for each characteristic, the Board and CEO cannot have a color indicator on the opposite end of the scale (namely Red & Green) as this indicates that their assessment regarding that particular characteristic is vastly different and a discussion is needed to examine and hopefully reconcile their assessment; and second, the difference between overall weighted average outcomes (Σᵢ₌₁ⁿ w_{i,t}y_{Board,i,t} & Σᵢ₌₁ⁿ w_{i,t}y_{CEO,i,t}) should be less than or equal to 15%, since the difference above this threshold is indicative of an overall misalignment between the assessment viewpoints of the CEO and Board. Hence a discussion exploring this misalignment would be beneficial. If either of these two pre-check decision rules are failed, messages may be transmitted to the CEO and to the Board members to initiate a meeting/discussion, calendars may be updated with a particular meeting entry, or a combination thereof. Provided that the above pre-check decision rules are satisfied, then an average is taken of the CEO's rating and the Board's aggregate rating. If the Board and CEO's discussion was not able to result in a reconciliation of assessment viewpoints, then the Board's aggregate rating is taken as the final overall aggregate rating.

In a particular implementation, the same decision rule (e.g., 146) is used for calculating an aggregate color indicator. For example, if the weighted average outcome is below (1−3*min wᵢ), then an aggregate Red is assigned, if the weighted average outcome is above (1−3*min wᵢ) but below (1−2*min wᵢ), then an aggregate Yellow is assigned, and if the weighted average outcome is above (1−2*min wᵢ), then an aggregate Green is assigned. As before, if min wᵢ<0.1, then substitute min wᵢ with second lowest wᵢ in the above calculations. The color indicator is output via a GUI. In some implementations, a warning may be issued if the Board's assessment of a particular characteristic has remained yellow for three consecutive periods. Additionally, or alternatively, a warning may be issued if the Board's assessment of a particular characteristic has remained red for two consecutive periods. The warning may include a warning message on a screen, a message to the CEO or the Board members, or any combination thereof.

The following formulas are used in determining the above-described values:

$$If for each i , \vert {y}_{Board , i , t} - {y}_{CEO , i , t} \vert \neq 1 \qquad Formula 11$$

$$If \vert {\sum }_{i = 1}^{n} {w}_{i , t} {y}_{Board , i , t} - {\sum }_{i = 1}^{n} {w}_{i , t} {y}_{CEO , i , t} \vert \leq 0.15$$

$$Then Aggregate Rating = \frac{{Score}_{CEO} + {Score}_{Board}}{2} ,$$

$$If \{ \begin{matrix}Aggregate Rating < ( 1 - 3 * min {w}_{i} ) * 7 \\ \begin{matrix}( 1 - 3 * min {w}_{i} ) * 7 \leq Aggregate Rating < \\ ( 1 - 2 * min {w}_{i} ) * 7\end{matrix} \\ ( 1 - 2 * min {w}_{i} ) * 7 \leq Aggregate Rating\end{matrix} , \qquad Formula 12$$

$$Then \{ \begin{matrix}Aggregate Color = Red \\ Aggregate Color = Yellow \\ Aggregate Color = Green\end{matrix}$$

To illustrate use of formulas 11-12, an example using the values determined above for the aggregate Board rating and the CEO rating is given. As explained above, both color ratings were Green, so the color ratings were not opposite (e.g., red and green) and 0.94−0.87=0.07<0.15, so the aggregate rating is determined as:

$$Aggregate Rating = \frac{6.1 + 6.55}{2} = 6.325 .$$

Additionally, since the aggregate rating is above the predetermined bound, 6.325>0.8*7=5.6, then Aggregate Color=Green.

In addition to processing the Board and CEO ratings, the DYLAM model processes the KPI values. In a particular implementation, in order to reflect overall KPI performance through a single score, a weighted average which takes individual hard KPIs and soft KPIs as inputs and calculates an overall score depending on the relative importance of each KPI is used. It is noted that each individual KPI's scoring responsibility is allocated to the corresponding Board function/Management member, which allows the scores to fully reflect each relevant stakeholders' view on the current performance of the firm.

To capture the individual significance that each KPI has on the overall process of quantifying performance, time dependent category weights (w_{i,t}) may be assigned to both the hard and soft categories. The use of time dependent category weights also allows for a more dynamic situation whereby the importance of each category can be adjusted depending on the specific phase the CEO and Board are in and any strategic objectives that they might hold. For example, the time dependent category weights may be modified based on a user input.

Individual time dependent KPI weights (w_{j,t}) may also be assigned to each KPI within a category to highlight each KPI's relative importance within that category. Again, the time dependent nature allows for dynamic adjustments.

Finally, by taking the products of both the category weights and individual KPI weights to each relevant KPI score and taking the summation of those products (Σᵢ₌₁ⁿΣⱼ₌₁^{m}w_{i,t}x_{i,j,t}), the final result (weighted averageₜ) is a weighted average of all KPI scores given their relative importance on overall performance. After the weighted averages have been calculated, an equivalent rating (Equivalent Ratingₜ) from 1 to 7 is also assigned based on which bracket the weighted average score falls into. In some implementations, the QCR coefficient may be applied to the Board's total equivalent rating, and a Q-Score may be calculated as the CEO and Board's average equivalent rating.

In a particular implementation, a rating 1 represents below 2; a rating 2 represents below 4 and 2 or above; a rating 3 represents below 5 and 4 or above; a rating 4 represents below 6.5 and 5 or above; a rating 5 represents below 7.5 and 6.5 or above; a rating 6 represents below 8.5 and 7.5 or above and a rating 7 represents 8.5 or above. In other implementations, other ratings ranges may be used.

The following formulas are used in determining the above-described values:

$$weighted {average}_{t} = {\sum }_{i = 1}^{n} {\sum }_{j = 1}^{m} {w}_{i} {w}_{j} {x}_{i , j , t} , \qquad Formula 13$$

$$If weighted {average}_{t} ∈ \{ \begin{matrix}[ 0 , 2 ) \\ [ 2 , 4 ) \\ [ 4 , 5 ) \\ [ 5 , 6.5 ) \\ [ 6.5 , 7.5 ) \\ [ 7.5 , 8.5 ) \\ [ 8.5 , 10 ]\end{matrix} , \qquad Formula 14$$

$$Then Equivalent {Rating}_{t} = \{ \begin{matrix}1 \\ 2 \\ 3 \\ 4 \\ 5 \\ 6 \\ 7\end{matrix}$$

The following example is to illustrate calculations associated with formulas 13-14. The performance metrics (e.g., KPIs) and weighting values are received. Values for the particular KPIs and weighting values are given in Table 6. These values represent one particular example, and are not limiting.

TABLE 6

| | | | Individual | |
|---|---|---|---|---|
| | Category | Key Performance | Indicator | |
| Category | Weight | Indicator | Weight | Score (out of 10) |
| (i) | (wᵢ) | (j) | (wⱼ) | (x_{i, j, t}) |
| 1 | 0.6 | Return on Asset | 0.2 | 8.5 |
| | | EBITDA | 0.15 | 9.5 |
| | | Growth Rate | 0.1 | 8 |
| | | Total Shareholder Return | 0.25 | 7.5 |
| | | Rev. per Consultant | 0.15 | 10 |
| | | Actual vs Forecast | 0.15 | 9.5 |
| | | Revenue | | |
| | | Weighted Average | | 8.725 |
| | | Equivalent Rating | | 7 |
| 2 | 0.3 | Employee Engagement | 0.5 | 8.5 |
| | | External Shareholder | 0.25 | 6 |
| | | Organization Wellness | 0.25 | 7.5 |
| | | Weighted Average | | 7.625 |
| | | Equivalent Rating | | 6 |
| 3 | 0.1 | Customer Satisfaction | 1 | 9 |
| | | Weighted Average | | 9 |
| | | Equivalent Rating | | 7 |
| Sum | 1 | Total Weighted | | 8.423 |
| | | Average | | |
| | | Equivalent Total | | 6 |
| | | Rating | | |

The weighted average is determined according to the following:

$$Weighted Average = {\sum }_{i = 1}^{n} {w}_{i} \times [ \begin{matrix}( {w}_{1} * {x}_{1 , 1} + {w}_{2} * {x}_{1 , 2} + … + {w}_{6} * {x}_{1 , 6} ) + \\ ( {w}_{1} * {x}_{2 , 1} + … + {w}_{3} * {x}_{2 , 3} ) + \\ ( {w}_{1} * {x}_{3 , 1} )\end{matrix} ]$$

Filling in the particular values yields:

$$\begin{matrix}= {\sum }_{i = 1}^{n} {w}_{i} \times [ \begin{matrix}( 0.2 * 8.5 + 0.15 * 9.5 + … + 0.15 * 10 + 0.15 * 9.5 ) + \\ ( 0.5 * 8.5 + 0.25 * 6 + 0.25 * 7.5 ) + ( 1 * 9 )\end{matrix} ] \\ = 0.6 * 8.725 + 0.3 * 7.625 + 0.1 * 9 \\ = 8.4225\end{matrix}$$

Because 8.4225 falls within the range [7.5, 8.5), the equivalent rating is 6.

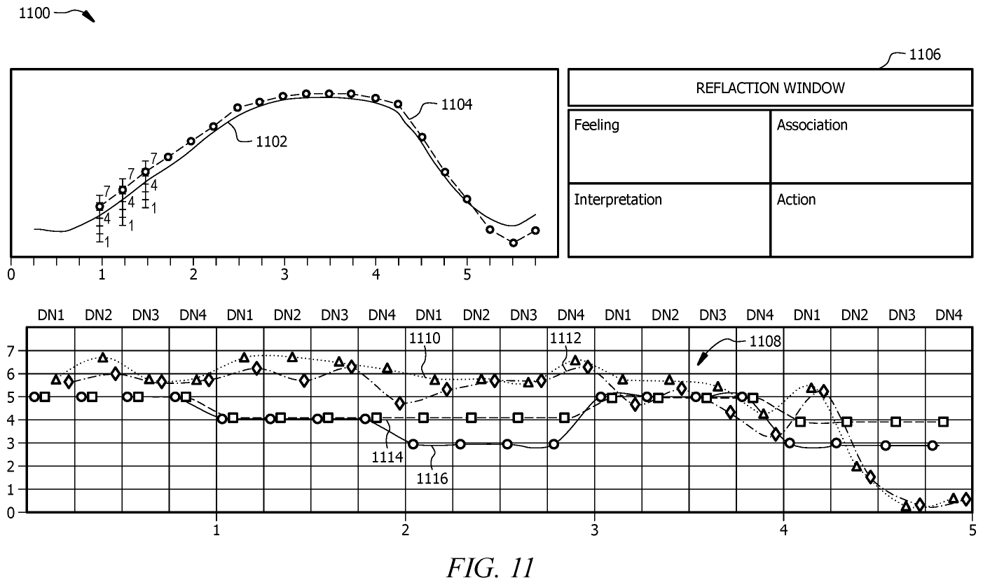

Once the various performance metrics have been processed to determine the ratings and the color indicators, the determined information may be output in a variety of visual forms via GUIs, as further illustrated with reference to FIGS. 2-11. For example, results may be plotted against a standardized conceptual performance model (e.g., curve), as shown in FIG. 11. This may provide visual guidance on how the CEO is performing against the Board's collective expectations. These visual analytics, combined with interpretative algorithms, provide better informed predictive insights into CEO performance and provide patterns of probable indicative causation that will: (i) promote better decision synchronization; (ii) result in higher levels of productivity and firm performance over the CEO's tenure; (iii) extend the CEO lifecycle; and (iv) ultimately provide a more informed and seamless leadership transition.

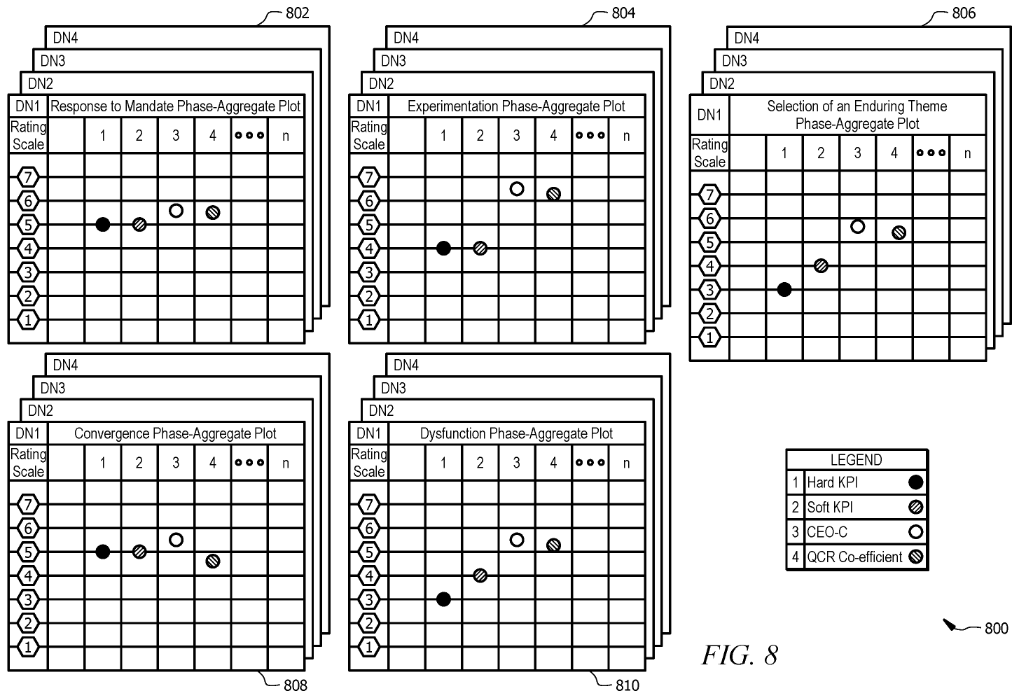

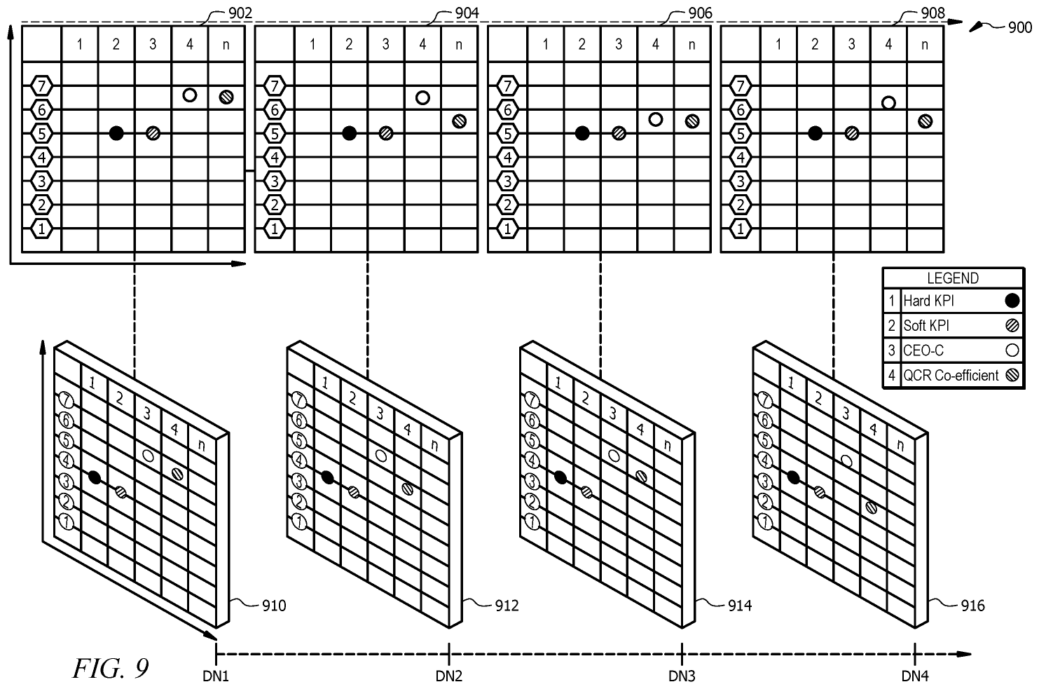

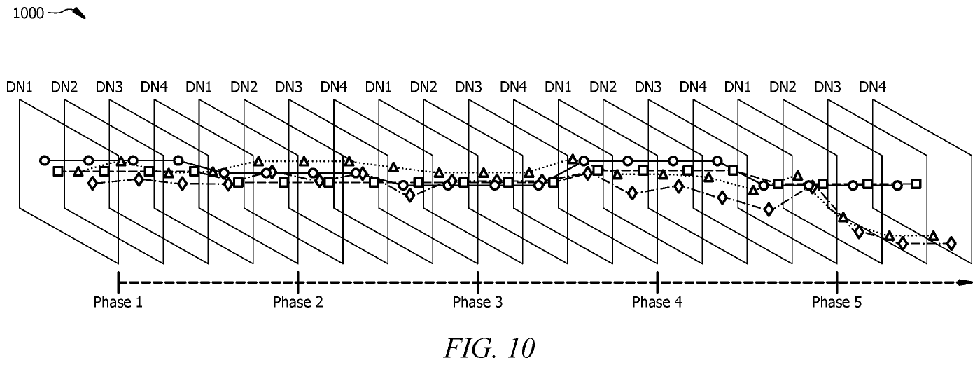

In some implementations, the aggregate scores from the DYLAM model may be plotted for each decision point. In a particular implementation, a simple 4 plot analysis of hard KPIs, soft KPIs, CEO characteristics (CEO-c), and QCR are plotted, as shown in FIG. 8. The data may be shown in 2-dimensional (2D) and three-dimensional (3D) formats. For example, the plots may be rotated in 3D to enable a user to view the data and intuitively and interactively explore the multi-layered connections and relationships embedded in the context of the CEO lifecycle, their inter-connectedness, and links to organizational performance, as shown in FIG. 9. The three-dimensional plots may be used to generate a 3D graph of the information, as shown in FIG. 10. Additionally, a 2D graph may be generated based on the 2D plots, as shown in FIG. 11.

During operation of system 100, server 130 compiles candidate data 136. Candidate data 136 may include data associated with a CEO who is to be hired (or who has been hired), such as information indicating performance measurements at a previous job, information indicating the identity of the CEO, information indicating knowledge or skills of the CEO, etc.

Server 130 initializes predictive analytics engine 138 based on at least a portion of the compiled candidate data and conceptual performance model 140 representative of an expected performance over a period of time. For example, server 130 (e.g., predictive analytics engine 138) may process at least a portion of candidate data 136 and generate conceptual performance model 140, which may be represented visually as a conceptual performance curve (e.g., graph). Conceptual performance model 140 may be based on candidate data 136. For example, candidate data 136 may be processed to indicate what performance level is to be expected of the CEO. Additionally, or alternatively, conceptual performance model 140 may be based on user input. For example, a member of the Board may input particular benchmarks decided on by the board to be implemented into conceptual performance model 140.

Server 130 (e.g., predictive analytics engine 138) processes performance metrics 142 to produce predictive performance metrics 144. For example, in response to detecting ratings corresponding to a particular level (e.g., a Yellow level) for a number of consecutive decision nodes, the predictive analytics engine 138 may predict that a future decision node will also result in a rating having the particular level. To attempt to prevent such an occurrence, server 130 may cause interactive tool 116 to output a warning message or to transmit a warning message to a device associated with the CEO, one or more Board members, or a combination thereof. Additionally, or alternatively, server 130 (e.g., predictive analytics engine 138) may perform interpolation or other operations to generate predictive performance metrics 144. Such operations may be based on performance metrics 142 (or values derived therefrom), conceptual performance model 140, or a combination thereof. For example, based on an actual performance value at a first time t1 and an expected value (e.g., based on conceptual performance model 140) at a second time, a predicted value at the second time may be determined.

In some implementations, processing performance metrics 142 may include accessing processing rules 146, pre-check rules 148, or a combination thereof. Pre-check rules 148 may include rules that determine whether re-evaluation is to be initiated, such as the decision divergence rule and the rule that the Board's aggregate rating and the CEO's rating should not be opposite color values (e.g., green and red). To illustrate, in a particular implementation, server 130 may determine that a difference between an average of two highest ratings for a particular performance metric and an average of two lowest ratings for the particular performance metric satisfies a threshold, and in response, server 130 initiates a redetermination of ratings for the particular performance metric. For example, if the difference between the average of the two highest Board member ratings and the average of the two lowest Board member ratings is greater than 3, server 130 may transmit messages to the Board members indicating that reassessment of the particular performance metric is requested. In another particular implementation, server 130 may access pre-check rules 148 to determine whether a difference between a first rating (e.g., an aggregate rating of the Board) and a second rating (e.g., a CEO rating) of a particular performance metric fail to satisfy a threshold (e.g., are opposite colors or are more than 15% different). Based on the difference failing to satisfy the threshold, server 130 may initiate a redetermination of ratings for the particular performance metric. For example, server 130 may transmit messages to the CEO and to the Board members indicating that reassessment is requested.

Processing rules 146 may include one or more rules that enable processing of performance metrics 142. For example, processing rules 146 may include rules for converting ratings values to indicia, such as colors. Additionally, processing rules 146 may include rules for aggregating ratings, applying QCR coefficients, etc. Processing rules 146 may be accessed while processing performance metrics 142.

In a particular implementation, processing performance metrics 142 may include determining (or generating) one or more ratings for corresponding performance metrics. For example, server 130 may identify ratings from one or more Board members, ratings from the CEO, or both. In some implementations, server 130 or interactive tool 116 may be configured to display one or more surveys to the CEO and the Board members to obtain the ratings. The surveys may include categories, sub-categories, or both, associated with CEO performance that may be ranked by the CEO or Board members, such as via user input. In some implementations, the surveys may include pop-windows or other displays of information that define metrics for the ratings to ensure consistent assessment by the individual Board members, sub-categories that ensure that all Board members share a common view on key performance metrics, provide continuity and calibration for new Board directors, and may put a spotlight on poorly calibrated views. The surveys may also include ratings for KPIs, and in some implementations each KPI may have a pop-up window or other information display that defines the pre-agreed objective, in addition or in the alternative to assignable category weights and individual indicator weights. Interactive tool 116 may be configured to display the one or more ratings with a first indicia if the one or more ratings satisfy a first threshold, a second indicia if the one or more ratings satisfy a second threshold, or a third indicia if the one or more ratings satisfy a third threshold. In a particular implementation, the first indicia includes a first color, the second indicia includes a second color, and the third indicia includes a third color. For example, interactive tool 116 may display performance metrics that do not satisfy a benchmark with a red color, performance metrics that substantially satisfy the benchmark with a yellow color, and performance metrics that exceed the benchmark with a green color, as described above.

In some implementations, processing performance metrics 142 may further include applying one or more weights to the one or more ratings to generate one or more weighted ratings corresponding to the performance metrics. For example, server 130 may access processing rules 146 to determine one or more time-based weights to apply to the ratings. Alternatively, interactive tool 116 may be configured to receive user input indicative of the one or more weights. Similar to as described above, in some such implementations, interactive tool 116 may be configured to select one or more indicia (e.g., one or more colors) for displaying the one or more weighted ratings based on satisfaction of one or more thresholds. In some implementations, server 130 may determine a coefficient value (e.g., a QCR coefficient) based on a number of a particular answer to a question compared to one or more thresholds and based on a minimum weight of the one or more weights. For example, server 130 may determine the QCR coefficient using formula 5. In some such implementations, processing performance metrics 142 may also include applying the coefficient value to one or more weighted ratings to generate one or more finalized ratings. For example, server 130 may apply the QCR coefficient according to formula 6.

Server 130 also dynamically modifies interactive tool 116 based on conceptual performance model 140 and performance metrics 142. Modifying interactive tool 116 may include causing interactive tool 116 to display predictive performance metrics 144. For example, modifying interactive tool 116 may include plotting current performance versus the conceptual performance model 140 in addition to plotting predicted performance at a later time. Additionally, or alternatively, modifying the interactive tool includes displaying conceptual performance model 140 and one or more decision nodes representing actual performance of the CEO over the period of time. For example, as further described with reference to FIG. 11, actual performance may be plotted alongside conceptual performance model 140 (e.g., a curve) to enable a user to identify how the actual performance of the CEO compares to the predicted performance associated with conceptual performance model 140. In some implementations, interactive tool 116 enables selection of one of the one or more decision nodes to initiate display of a performance measurement window that displays one or more performance metrics relative to expected values, as further described with reference to FIG. 6. In some such implementations, interactive tool 116 enables selection of one of the performance metrics to initiate display of a sub-category window that displays one or more sub-category measurements, as further described with reference to FIG. 7. Additionally, or alternatively, interactive tool 116 may enable display of a 3D graph of a subset of performance metrics at times corresponding to the one or more decision nodes, as further described with reference to FIG. 10.

In some implementations, interactive tool 116 is included in (or interacts with) an application executed by a mobile device, or other electronic device, of the user. The application (e.g., interactive tool 116) may provide the CEO and Board with predictable and actionable insights into the emotional and behavioral characteristics that improve CEO and Board performance. Additionally, the application (e.g., interactive tool 116) may help synchronize the Board and CEO's decision matrix on key soft and hard performance decisions to identify divergences, which may improve the Board's QCR in a fast changing business environment.

Thus, system 100 describes a system for using a predictive analytics engine (e.g., 138) to modify an interactive tool (116). The predictive analytics engine processes performance metrics (e.g., 142) to generate predictive performance metrics (e.g., 144). Additionally, modifying the interactive tool may enable display of various visualizations of the processed performance metrics. Using DYLAM as the basis for the predictive analytics engine enable a user, such as the CEO or a Board member, to understand the relationship between the CEO's performance and an expected performance, as well as the relationships between the CEO's view of his/her tenure and the Board's view, and the relationship between the various performance metrics. Additionally, the information may include predicted values for how the CEO is to perform in the future, which may assist the Board in determining how to extend the CEO's tenure or whether it is time to begin a transition to a new CEO. System 100 may provide the Board with a predictive capability on CEO behavior which may enable the Board to more effectively mentor the CEO of their life-cycle, improved decision quality, consistency, and responsivity, and better Chair and CEO partnership. Additionally or alternatively, system 100 may significantly “de-risk” a new CEO's transition into the CEO role, provide performance benchmarks that enable continuous improvement and renewal, and provide a “common lens” with the Board to identify and rectify emerging emotional and behavioral misalignment. Additionally or alternatively, system 100 may enable an advisor to expand from CEO succession planning to implementing the new CEO, provide an objective framework to help the CEO achieve higher levels of sustained performance for their business, and through interactive tool 116, leverage digital platforms, intellectual properties, and big data analysis to support the advisor, the Board, and the CEO.

Referring to FIG. 2, a user interface that displays a conceptual performance model and one or more scales is shown and designated 200. User interface 200 includes one or more scales, information related to CEO characteristics during particular time periods (e.g., “seasons”), as described with reference to FIG. 1, and a conceptual performance curve.

To illustrate, user interface 200 includes one or more scales, including illustrative first scale 202. The scales indicate values of a CEO characteristic during a particular time period, as further described herein with reference to FIG. 3. User interface 200 also includes information regarding expected characteristics with respect to the characteristics and time periods shown in FIG. 2. The characteristics include Commitment to a Paradigm, Task Knowledge, Information Diversity, Task Interest, Power, and Agility. The time periods (e.g., seasons) include Response to Mandate, Experimentation, Selection of an Enduring Theme, Convergence, and Dysfunction. The information shown in FIG. 2 may include or correspond to the information included in Table 1. Additionally, in FIG. 2, the Response to Mandate time period is broken up into to sub-time periods: Pre-entry and Entry, which provides a more detailed view of this time period. Additionally, the Dysfunction time period includes an Exit sub-time period and a Post-Exit sub-time period, which provides a more detailed view of this time period.

User interface 200 also includes a conceptual performance curve 210. Conceptual performance curve 210 indicates expected performance of the CEO over a plurality of time periods (e.g., seasons). Conceptual performance curve 210 may include or correspond to conceptual performance model 140. Conceptual performance curve 210 may include a plurality of decision nodes, such as illustrative decision node 212, that represent points at which performance metrics, such as performance metrics 142, are processed. As further described herein with reference to FIG. 6, the decision nodes may be selectable (e.g., via user input) to provide additional information about the performance metrics.

User interface 200 may be displayed based on selecting an option via interactive tool 116. For example, interactive tool 116 may display, at electronic device 110, a menu of different informational options to be displayed. In response to selecting an option for CEO characteristic information and conceptual performance curve, user interface 200 may be displayed.

Referring to FIG. 3, a user interface that displays a plurality of scales is shown and designated 300. User interface 300 represents a numeric CEO scale. For example, user interface 300 includes a plurality of scales (e.g., ranges). To illustrate, each of the five dimensions (e.g., characteristics) of a CEO described with reference to FIG. 1 are provided with a scale (e.g., a 1 to 7 point scale in a non-limiting implementation) for each of the five time periods/phases (e.g., “seasons”) of the CEO lifecycle described with reference to FIG. 1. Markers (e.g., triangles and squares in the example illustrated in FIG. 3) are illustrated at positions that reflect the “standardized” patterns that generally occur during a CEO's tenure.

As an example, a first scale 302 indicates a rating for the Commitment to a Paradigm characteristic for the Response to Mandate time period. First scale 302 includes a first marker 304 that indicates an expected rating for the CEO with respect to this characteristic during this time period. Additional scales are indicated for the Commitment to a Paradigm characteristic for the Experimentation time period, the Selection of an Enduring Theme time period, the Convergence time period, and the Dysfunction time period. Additional scales are also included for the Task Knowledge characteristic, the Information Diversity characteristic, the Task Interest characteristic, the Power characteristic, and the Agility characteristic, across the five described time periods (e.g., seasons).

In addition to illustrating the scales, the scales are illustrated with corresponding indicia to indicate the desired or target (e.g., “ideal”) values (e.g., values above a benchmark), the acceptable values (e.g., values that meet a benchmark), and the below acceptable values (e.g., values below the benchmark). In a particular implementation, the indicia may comprise illustrating various ranges with different colors. For example, target values may be colored green, acceptable values may be colored yellow, and below acceptable values may be colored red. Color coding is illustrated in the bottom row of user interface 300.

In some implementations, the indicia (e.g., colors) are preprogrammed. In other implementations, the indicia are based on user input. For example, a user may define what range of values are target values, acceptable values, and/or below acceptable values for the various characteristics and time periods (e.g., seasons). This enables the Board to decide what characteristics are important at particular times, for the particular industry, based on a particular business plan, etc.

User interface 300 may be displayed based on selecting an option via interactive tool 116. For example, interactive tool 116 may display, at electronic device 110, a menu of different informational options to be displayed. In response to selecting an option for CEO characteristic scale, user interface 300 may be displayed.

Thus, user interface 300 displays scales of values of CEO characteristics at various time periods. The scales are color coded (or use other indicia) to indicate target values, acceptable values, and below acceptable values. Plotting actual CEO performance on these scales may provide users with valuable information on how to improve CEO performance at various times.

Referring to FIG. 4, a user interface that displays a conceptual performance model and a plurality of scales is shown and designated 400. User interface 400 combines the plurality of scales described with reference to FIG. 3 with a conceptual performance model (e.g., a curve).

To illustrate, user interface 400 includes a plurality of scales, including illustrative first scale 402. The scales indicate values of a CEO characteristic during a particular time period, as described with reference to FIG. 3. User interface 400 also includes a conceptual performance curve 410. Conceptual performance curve 410 indicates expected performance of the CEO over a plurality of time periods (e.g., seasons). Conceptual performance curve 410 may include or correspond to conceptual performance model 140. Conceptual performance curve 410 may include a plurality of decision nodes, such as illustrative decision node 412, that represent points at which performance metrics, such as performance metrics 142, are processed. As further described herein with reference to FIG. 6, the decision nodes may be selectable (e.g., via user input) to provide additional information about the performance metrics.

User interface 400 may be displayed based on selecting an option via interactive tool 116. For example, interactive tool 116 may display, at electronic device 110, a menu of different informational options to be displayed. In response to selecting an option for CEO characteristic scale and conceptual performance curve, user interface 400 may be displayed.

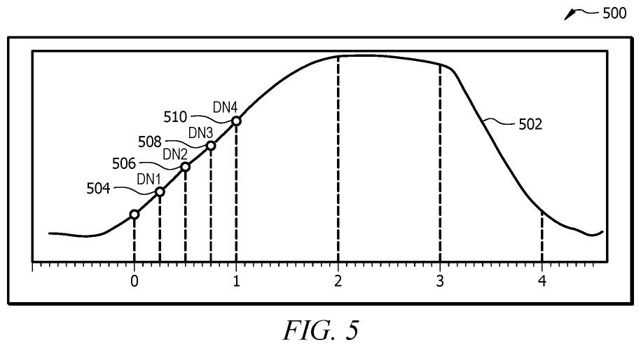

Referring to FIG. 5, a user interface that displays a conceptual performance model is shown and designated 500. User interface 500 includes a conceptual performance curve 502. Conceptual performance curve 502 indicates expected performance of the CEO over a plurality of time periods (e.g., seasons). Conceptual performance curve 502 may include or correspond to conceptual performance model 140.

Conceptual performance curve 502 includes a plurality of decision nodes including first decision node 504 (“DN1”), second decision node 506 (“DN2”), third decision node 508 (“DN3”), and fourth decision node 510 (“DN4”). The decision nodes 504-510 are plotted at x-y positions on conceptual performance curve 502. In a particular implementation, conceptual performance curve 502 may correspond to a default value of 4 (on a 1 to 7 scale). In other implementations, conceptual performance curve 502 may correspond to a different default value and have a different shape. Conceptual performance curve 502 represents a point of origin for plotting the relative performance of the CEO and multiple points in time and provides a conceptual baseline for predicting positive or negative performance versus the collective “expectation” of the CEO and Board at each decision node.

In a particular implementation, each of the decision nodes 504-510 are matched to quarterly reporting requirements of publicly listed companies. In other implementations, the decision nodes correspond to other frequencies of time (e.g., not quarterly). Although four decision nodes are described, in other implementations, fewer than four or more than four decision nodes may be included on conceptual performance curve 502. In some implementations, each decision node of decision nodes 504-510 may be selected to provide additional information, as further described with reference to FIG. 6. For example, selection of a decision node (e.g., based on user input) via interactive tool 116 enables display of information related to performance metrics, as further described with reference to FIG. 6.

Referring to FIG. 6, a user interface that displays a model of a conceptual performance model and a performance measurements window is shown and designated 600. User interface 600 includes conceptual performance curve 602, similar to conceptual performance curve 502. Conceptual performance curve 602 may include or correspond to conceptual performance model 140. Conceptual performance curve 602 includes a plurality of decision nodes, include illustrative decision node 604 (“DN4”).

Interactive tool 116 may enable a user to select one of the plurality of decision nodes to display additional information associated with the selected decision node. For example, responsive to selection of decision node 604, a performance measurement window 606 may be displayed. Performance measurement window 606 includes performance metrics associated with decision node 604 (e.g., measurements associated with a time of decision node 604). For example, performance measurement window 606 may include a first performance metric indicator 610, a second performance metric indicator 612, a third performance metric indicator 614, and a fourth performance metric indicator 616. Although four performance metric indicators 610-616 are illustrated, in other implementations, fewer than four or more than four performance metric indicators may be displayed.

Performance metric indicators 610-616 illustrate values of performance metrics that make up the overall score associated with decision node 604. In a particular implementation, first performance metric indicator 610 corresponds to hard KPIs, second performance metric indicator 612 corresponds to soft KPIs, third performance metric indicator 614 corresponds to CEO characteristics (CEO-C), and fourth performance metric indicator 616 corresponds to QCR coefficients. Each of the performance metric indicators 610-616 represents an aggregate value, and can be further broken down into respective sub-category values, as further described with reference to FIG. 7. Data measurement categories can move up and down (as indicated by arrows) the measurement scale dynamically in a quasi-real time sequence (e.g., from decision node to decision node). Hard and soft KPIs are treated equally through the process of datafication. The DYLAM model provides useful probabilistic indicative causality (PIC) over a CEO's lifecycle.

Additionally or alternatively, user interface 600 may display KPI values, peer group performance measurements, CEO ratings, or a combination thereof, on conceptual performance curve 602. The CEO ratings may indicate a level of synchronization between the CEO and the Board on key characteristics that impact CEO performance. In some implementations, the CEO ratings may be color-coded, or otherwise visually configured, to indicate different levels, such as “on track,” “attention required,” or “urgent action,” as non-limiting examples. In some implementations, if ratings for three consecutive decision nodes have a second value (e.g., attention required) instead of a first level (e.g., on track), then the next decision node may be automatically flagged as a third level (e.g., urgent action), to indicate that the synchronization between the CEO and the Board has not returned to a target level within particular time period, and that additional actions may be suggested or utilized to improve the synchronization before the lack of synchronicity degrades performance of the CEO or the organization. In some implementations, conceptual performance curve 602 is a 2D graph. Alternatively, as further described herein, conceptual performance curve 602 may be a 3D graph. Additionally or alternatively, conceptual performance curve 602 (or any other informational display described herein) may be presented with enhanced features, such as dynamic data analysis and pattern recognition, as non-limiting examples.

Referring to FIG. 7, a user interface that displays multiple sub-category windows is shown and designated 700. The multiple sub-category windows may be displayed based on selection of performance metrics within the windows (e.g., based on a user input).

To illustrate, user interface 700 includes a first window 702. First window 702 may include or correspond to performance measurement window 606 that is displayed in response to selection of a decision node. First window 702 may include multiple performance metrics indicators. In the example of FIG. 7, first window 702 includes performance metrics indicators corresponding to CEO-C, hard KPIs, soft KPIs, and QCR coefficients.

Selection of one of the performance metrics indicators causes display of a sub-category window. For example, selection of the CEO-C performance metric indicator causes interactive tool 116 to display sub-category window 704. Sub-category window 704 includes a plurality of sub-category performance metric indicators, such as illustrative sub-category performance metric indicator 706. Each of the sub-category performance metric indicators illustrate values of performance metrics that make up the overall score associated with the particular category. For example, each of the sub-category performance metric indicators of sub-category window 704 illustrates values of performance metrics that make up the CEO-C score.

In some implementations, the sub-category performance metric indicators are further selectable to cause interactive tool 116 to display additional sub-category windows (e.g., sub-sub-category windows). For example, selection of sub-category performance indicator 706 may cause display of second sub-category window 708. In the example of FIG. 7, second sub-category window 708 corresponds to Task Interest sub-categories. Second sub-category window 708 may include a plurality of sub-category performance metrics indicators that indicate values of various performance metrics associated with Task Interest sub-categories. As another example, selection of a different sub-category performance indicator may cause display of third sub-category window 710. In the example of FIG. 7, third sub-category window 710 corresponds to Power Relations sub-categories. Third sub-category window 710 may include a plurality of sub-category performance metrics indicators that indicate values of various performance metrics associated with Power Relations sub-categories. In some implementations, selection of a sub-category performance metrics indicator in second sub-category window 708 or third sub-category window 710 may cause display of another sub-category window with additional information. Alternatively, selection of the sub-category performance metrics indicator may cause display of individual CEO and Board member inputs for the corresponding performance metric. Thus, each of the performance management categories can be expanded in the same way as illustrated for the CEO characteristics to match the complexity of the system it exists within.

Thus, FIG. 7 illustrates how interactive tool 116 can provide hierarchical levels of information about performance metrics corresponding to a conceptual performance model. By displaying various sub-category windows, additional, lower-level information may be displayed, in some implementations all the way down to the individual inputs that make up the aggregated scores. Using these windows, a user may be able to gain insight into the information presented by the conceptual performance model (e.g., 140).

Referring to FIG. 8, a user interface that displays multiple performance metrics plots is shown and designated 800. For example, user interface 800 may display a first set of performance metrics plots 802, a second set of performance metrics plots 804, a third set of performance metrics plots 806, a fourth set of performance metrics plots 808, and a fifth set of performance metrics plots 810. Each plot of the sets of performance metrics plots may correspond to a respective decision node. Each set of performance metrics plots 802-810 may correspond to a different time period (e.g., season) of the CEO's tenure. For example, first set of performance metrics plots 802 may correspond to Response to Mandate, second set of performance metrics plots 804 may correspond to Experimentation, third set of performance metrics plot 806 may correspond to Selection of an Enduring Theme, fourth set of performance metrics plot 808 may correspond to Convergence, and fifth set of performance metrics plots 810 may correspond to Dysfunction.

Each performance metrics plot may include plots of various performance metrics, or aggregate performance metrics. In the example of FIG. 8, each plot includes an entry corresponding to hard KPIs, an entry corresponding to soft KPIs, an entry corresponding to CEO-C, and an entry corresponding to QCR coefficient. In other implementations, fewer than four or more than four performance metrics may be plotted.

Although only one performance metrics plot for each set of performance metrics plots is fully visible, in some implementations, interactive tool 116 may enable user selection of any of the plots, and upon selection, the selected plot will be displayed fully. In this manner, each of the performance metrics plots may be viewable.

User interface 800 may be displayed based on selecting an option via interactive tool 116. For example, interactive tool 116 may display, at electronic device 110, a menu of different informational options to be displayed. In response to selecting an option for performance metrics plots, user interface 800 may be displayed.

Referring to FIG. 9, a user interface that displays a three-dimensional rotation of multiple performance metrics plots is shown and designated 900. User interface 900 includes multiple 2D performance metrics plots. For example, user interface 900 includes first performance metrics plot 902, second performance metrics plot 904, third performance metrics plot 906, and fourth performance metrics plot 908. In some implementations, performance metrics plots 902-908 may be displayed based on a user input to user interface 800. For example, selection of a particular set of performance metrics plots may result in display of each of the performance metrics plots of the set concurrently. In some implementations, each plot may correspond to a respective decision node.

In addition to displaying the 2D performance metrics plots 902-908, user interface 900 may also display 3D performance metrics plots. The 3D performance metrics plots may be generated by rotating the corresponding 2D performance metrics plots. For example, first performance metrics plot 902 may be rotated to generate first rotated performance metrics plot 910, second performance metrics plot 904 may be rotated to generate second rotated performance metrics plot 912, third performance metrics plot 906 may be rotated to generate third rotated performance metrics plot 914, and fourth performance metrics plot 908 may be rotated to generate fourth rotated performance metrics plot 916. Rotating the performance metrics plots creates a 3D visualization that may visually highlight data correlations and emergent patterns. In some implementations, each performance metric is color coded to provide easier pattern recognition.

Thus, FIG. 9 illustrates display of 2D and 3D formats of performance metrics using various visualizations. The visualizations may enable users, such as the CEO and Board members, to intuitively and interactively explore the multi-layered connections and relationships embedded within the performance metrics, their interconnectedness, and links to organizational performance.

Referring to FIG. 10, a user interface that displays a three-dimensional graph of various performance metrics is shown and designated 1000. User interface 1000 may include 3D graphs of the performance metrics plotted in the performance metrics plots of user interfaces 800 and 900. For example, user interface 900 may include an option to view graphs based on the rotated performance metrics plots. The graphs may display the performance metrics across the decision nodes of each of the time periods (e.g., phases/seasons) of the CEO's tenure (or the time periods for which data is available). Such visualization may highlight data correlation and emergent patterns, and make it easier for a user to perceive the connections between the performance metrics.

Referring to FIG. 11, a user interface that displays a conceptual performance model and actual performance measurements in addition to a graph of performance metrics is shown and designated 1100. User interface 1100 may display conceptual performance curve 1102, similar to conceptual performance curve 602. Conceptual performance curve 1102 may include or correspond to conceptual performance model 140. As described herein, conceptual performance curve 1102 may illustrate expected values of performance metrics during the tenure of the CEO.

User interface 1100 may also display actual values 1104. Actual values 1104 may be based on performance metrics measured during the tenure of the CEO. In a particular implementation, actual values 1104 are measured at times corresponding to decision nodes. Displaying actual values 1104 alongside conceptual performance curve 1102 may enable a user to quickly and easily determine how the CEO is performing as compared to expectations.

In some implementations, user interface 1100 may also include a reflaction window 1106. Reflaction window 1106 may include entries for a feeling, an association, an interpretation, and/or an action associated with a selected actual value (or alternatively, with the entirety of actual values 1104). Reflaction window 1106 may provide additional insight into the mindset of the CEO at various points throughout the tenure.

A core strength of DYLAM is the ability to flex with complexity and analyze multiple layered interconnections and relationships. For example, in FIG. 11, DYLAM provides an algorithmic platform that enables multiple levels of data layers (e.g., 1. Feelings, 2. Associations (psychological spikes into ones subconscious, which can be numeric values based on different psychological rating scales), 3. Interpretations, and 4. Actions). These data layers are then linked to events or time specific criteria to assess to provide predictive behavioral guidance to the CEO and Board.

In some implementations, user interface 1100 also includes a 2D graph 1108 of performance metrics. Graph 1108 may graph the performance metrics that are plotted in sets of performance metrics plots 802 through 810. In other implementations, graph 1108 may be included in a different display so as not to draw focus away from the relationship between conceptual performance curve 1102 and actual values 1104. In some implementations, graph 1108 includes a first curve 1110 corresponding to CEO characteristics, a second curve 1112 corresponding to a QCR coefficient, a third curve 1114 corresponding to soft KPIs, and a fourth curve 1116 corresponding to hard KPIs.

User interface 1100 may be displayed based on selecting an option via interactive tool 116. For example, interactive tool 116 may display, at electronic device 110, a menu of different informational options to be displayed. In response to selecting an option for actual performance vs. conceptual performance information and/or 2D performance metrics information, user interface 1100 may be displayed.

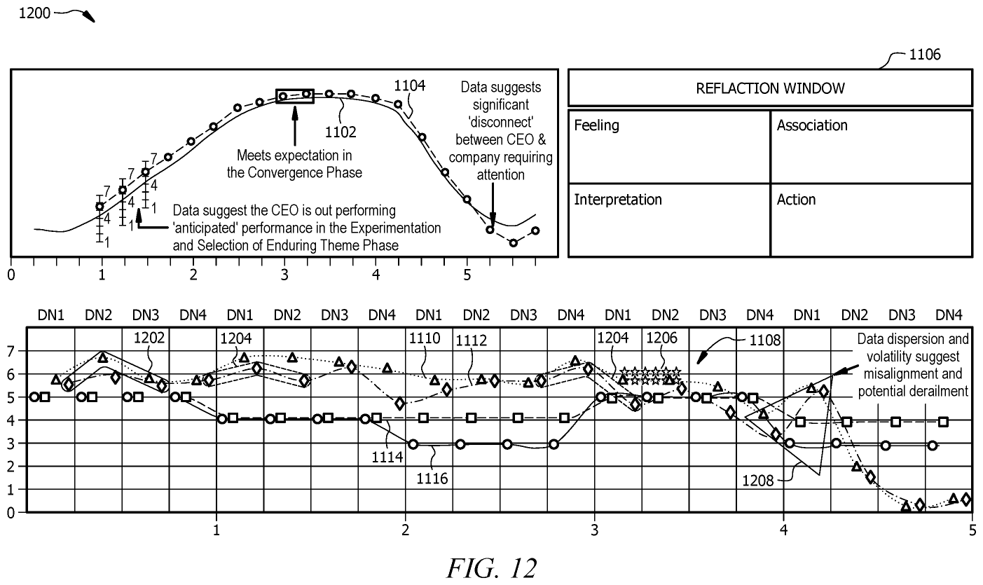

Referring to FIG. 12, a user interface that displays a conceptual performance model and actual performance measurements in addition to a graph of performance metrics is shown and designated 1200. User interface 1200 is similar to user interface 1100, except that additional indicators are illustrated in user interface 1200.

FIG. 12 illustrates various information derived from conceptual performance curve 1102 and actual values 1104. The information may be used as part of an iterative feedback cycle that tracks and measures the level of performance synchronization for the CEO, including identifying opportunities for CEO improvement and renewal (e.g., intervention and improvement) at various times (e.g., “performance checks”). In a particular implementation, difference in the actual values 1104 compared to conceptual performance curve 1102 during year 1 to year 2 indicate that the CEO is outperforming “anticipated” performance in the Experimentation and Selection of an Enduring Theme phases. The actual values 1104 during year 3 indicate that the CEO is meeting expectations in the Convergence phase. The difference between actual values 1104 and conceptual performance curve 1102 during year 5 suggest “disconnect” between the CEO and the corporations, which may require attention.

FIG. 12 also includes one or more indicators that indicate information derived from graph 1108. In a particular implementation, user interface 1200 includes a first indicator 1202 between decision nodes 1-3 of year 1, which corresponds to a −0.7 QCR coefficient that indicates the subsequent triggering of the DDR rule at DN2 showing Board members to be misaligned. At DN3, after the DDR and the Board performed the realignment discussion, better Board alignment with better QCR is seen. User interface 1200 includes second indicators 1204 between DN4 of year 1 and DN2 of year 2 and between DN3 of year 3 and DN1 of year 4, which indicates an increased gap between the Aggregate CEO and Board Rating and Q-Score due to the drop in QCR coefficient. This may be a result of new Board members needing alignment or an indication of Board members placed by activist shareholders. User interface 1200 includes third indicator 1206 between DN1 and DN2 of year 4, which indicates that it is initially unable to reach an Aggregated CEO and Board Rating due to the opposite color assessments for individual characteristics, which subsequently indicates a misalignment between the CEO and the Board, foreshadowing the imminent entrance into the Dysfunction phase. Additionally, user interface 1200 includes fourth indicator 1208 that indicates data dispersion and volatility from DN4 of year 4 to DN1 of year 5 and suggests misalignment and possible derailment. Thus, user interface 1200 may display indicators to highlight various information derived from graph 1108.

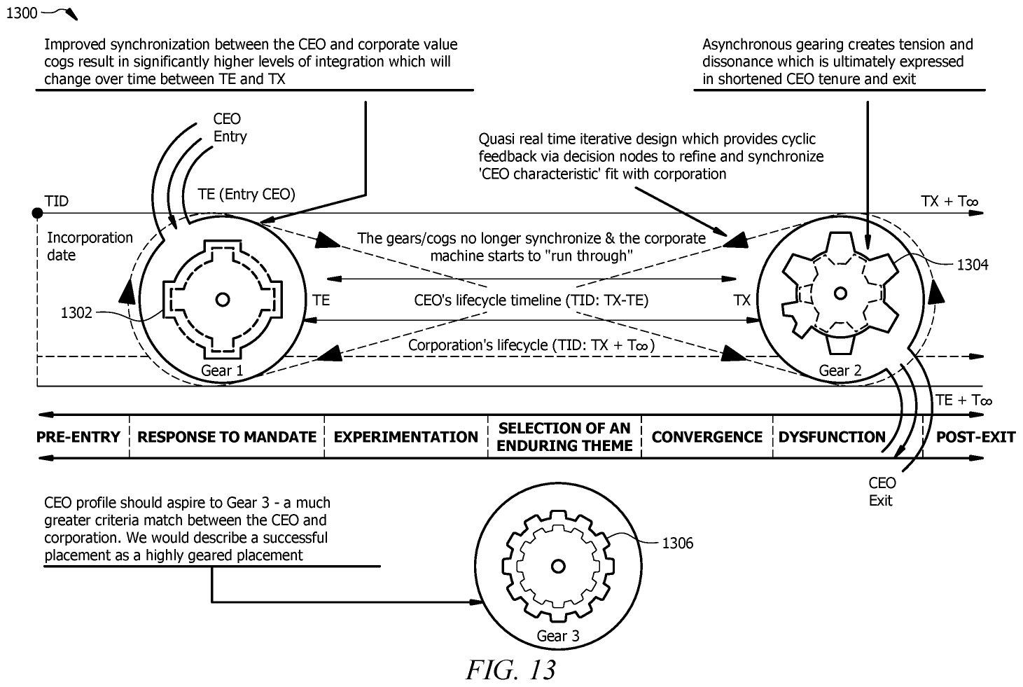

Referring to FIG. 13, an example of a user interface that displays cognitive gearing model is shown and designated 1300. The cognitive gearing model of user interface 1300 provides a conceptual model for formulating an effective decision algorithm.

In a particular implementation, the cognitive gearing model includes a first gear 1302, a second gear 1304, and a third gear 1306. In other implementations, more than three gears or fewer than three gears may be included in the cognitive gearing model. In a particular implementation, first gear 1302 corresponds to an entry time of the CEO. First gear 1302, due to the aligned “teeth” of the gears, indicates improved synchronization between the CEO and corporate value cogs that result in significantly higher levels of integration (which may change over time before the CEO's exit). The cognitive gearing model provides cyclic feedback via decision nodes to refine and synchronize “CEO characteristic” fit with the corporation. Second gear 1304 may correspond to a time near exit of the CEO and may have asynchronous gearing (e.g., mismatched cogs or teeth) which creates tension and dissonance which ultimately may be expressed in shorted CEO tenure and exit. Third gear 1306 represents an aspirational situation in which a much greater criteria match between the CEO and the corporation exits. Such a placement (of CEO in the company) could be described as a successful placement, also referred to as a “highly geared” placement.

The cognitive gearing model has a high level of scalability. Each of the teeth on the cogs may be construed as a characteristic. The more cogs with more teeth, the more highly “geared” a corporation becomes. The more highly geared any engine becomes, the more smoothly it runs. The ability to zoom in and zoom out and provide enhanced clarity on the linkages between the different cognitive gears of the executive levels in the corporation make the cognitive gear model a particularly useful tool. The better the gears “mesh”, the more smoothly the corporation will run with the CEO transitioning smoothly in and out of the corporate “machine” and the next CEO sliding relatively seamlessly into their place. The benefits of this aspect of the DYLAM model are that it highlights how synchronization and iterative feedback loops can underwrite CEO performance over the CEO lifecycle. DYLAM includes a design methodology based on a cyclic feedback process to refine a characteristic (or combination of characteristics) that “fit” the gearing of a particular corporation across time. The outcome is a successful CEO tenure from pre-entry to post-exit, minimizing disruption to the company and protecting its share value and greatly facilitating the CEO lifecycle running smoothly without gears grinding and with less chance of derailment over time.

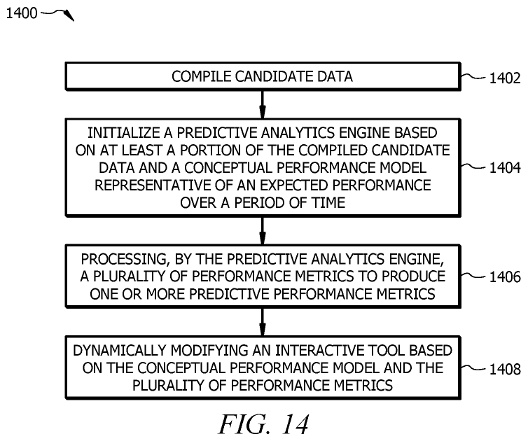

FIG. 14 is a flow diagram of a method for using a predictive analytics engine to modify an interactive tool according to an aspect is shown as a method 1400. Method 1400 may be stored in a computer-readable storage medium as instructions that, when executed by one or more processors, cause the one or more processors to perform the operations of the method 1400. In a particular implementation, method 1400 may be performed by server 130 (e.g., one or more processors 132).

At 1402, method 1400 includes compiling candidate data. For example, server 130 may compile candidate data 136.

At 1404, method 1400 includes initializing a predictive analytics engine based on at least a portion of the compiled candidate data and a conceptual performance model representative of an expected performance over a period of time. For example, server 130 may initialize predictive analytics engine 138 based on at least a portion of candidate data 136 and conceptual performance model 140. In a particular implementation, conceptual performance model 140 includes a conceptual performance curve (e.g., graph) representative of the expected performance over the period of time.

At 1406, method 1400 includes processing, by the predictive analytics engine, a plurality of performance metrics to produce one or more predictive performance metrics. For example, predictive analytics engine 138 may process performance metrics 142 to generate predictive performance metrics 144. In a particular implementation, the plurality of performance metrics include hard key performance indicators (KPIs), soft KPIs, ratings, a coefficient value, or a combination thereof.

At 1408, method 1400 further includes dynamically modifying an interactive tool based on the conceptual performance model and the plurality of performance metrics. For example, server 130 may modify interactive tool 116 based on conceptual performance model 140 and performance metrics 142.

In a particular implementation, processing the plurality of performance metrics includes generating one or more ratings for corresponding performance metrics. For example, processing performance metrics 142 may include identifying one or more Board member ratings, one or more CEO ratings, or a combination thereof. In some such implementations, the interactive tool is configured to display the one or more ratings with a first indicia if the one or more ratings satisfy a first threshold, a second indicia if the one or more ratings satisfy a second threshold, or a third indicia if the one or more ratings satisfy a third threshold. The first indicia may include a first color, the second indicia may include a second color, and the third indicia may include a third color. For example, interactive tool 116 may display the one or more ratings with a red color if the ratings fail to satisfy a benchmark, with a yellow color if the one or more ratings substantially satisfy the benchmark, or with a green color if the one or more ratings exceed the benchmark.

In some such implementations, processing the plurality of performance metrics further includes applying one or more weights to the one or more ratings to generate one or more weighted ratings for corresponding performance metrics. For example, server 130 may apply one or more weights to the ratings to generate one or more weighted ratings. In some such implementations, interactive tool 116 is configured to receive user input indicative of the one or more weights. Alternatively, server 130 may access processing rules 146 to identify the one or more weights. In some such implementations, the interactive tool is configured to select one or more indicia for displaying the one or more weighted ratings based on satisfaction of one or more thresholds. For example, interactive tool 116 may display the weighted ratings with a red color, a yellow color, or a green color, as described with reference to FIG. 1.

In some such implementations, method 1400 further includes determining a coefficient value based on a number of a particular answer to a question compared to one or more thresholds and based on a minimum weight of the one or more weights. For example, server 130 may determine a QCR coefficient based on the number of “no's” from the Board members and the minimum weight, according to formula 5. In some such implementations, processing the performance metrics includes applying the coefficient value to one or more weighted ratings to generate one or more finalized ratings. For example, server 130 may apply the QCR coefficient according to formula 6.

In a particular implementation, method 1400 may also include determining that a difference between an average of two highest ratings for a particular performance metric and an average of two lowest ratings for the particular performance metric satisfies a threshold. In this implementation, method 1400 further includes initiating a redetermination of ratings for the particular performance metric. For example, server 130 may access pre-check rules 148 to apply the decision divergence rule, as described with reference to FIG. 1.

In a particular implementation, modifying the interactive tool includes displaying the conceptual performance model and one or more decision nodes representing actual performance over the period of time. For example, modifying interactive tool 116 may include displaying conceptual performance model 140 and one or more decision nodes representing actual performance over the period of time, as described with reference to FIG. 6. In some such implementations, the interactive tool enables selection of one of the one or more decision nodes to initiate display of a performance measurement window that displays one or more performance metrics relative to expected values, as further described with reference to FIG. 6. In some such implementations, the interactive tool enables selection of one of the performance metrics to initiate display of a sub-category window that displays one or more sub-category measurements, as further described with reference to FIG. 7. In some such implementations, the interactive tool enables display of a three-dimensional graph of a subset of performance metrics at times corresponding to the one or more decision nodes, as further described with reference to FIG. 10. Additionally, or alternatively, modifying the interactive tool includes causing the interactive tool to display the one or more predictive measurements.

In a particular implementation, method 1400 also includes accessing pre-check rules to determine whether a difference between a first rating of a particular performance metric and a second rating of a particular performance metric satisfy a threshold. In this implementation, method 1400 further includes, based on the difference failing to satisfy the threshold, initiating a redetermination of ratings for the particular performance metric. For example, server 130 may access pre-check rules 148 to determine whether a difference between a CEO rating and an aggregate Board rating satisfy a threshold and, if the difference fails to satisfy the threshold, initiate a redetermination of the ratings (e.g., by transmitting messages to the CEO and the Board members requesting a discussion for a redetermination).

Thus, method 1400 describes a method for using a predictive analytics engine to modify an interactive tool. Method 1400 may enable processing of performance metrics to generate predictive performance metrics. Additionally, modifying the interactive tool may enable display of various visualizations of the processed performance metrics.

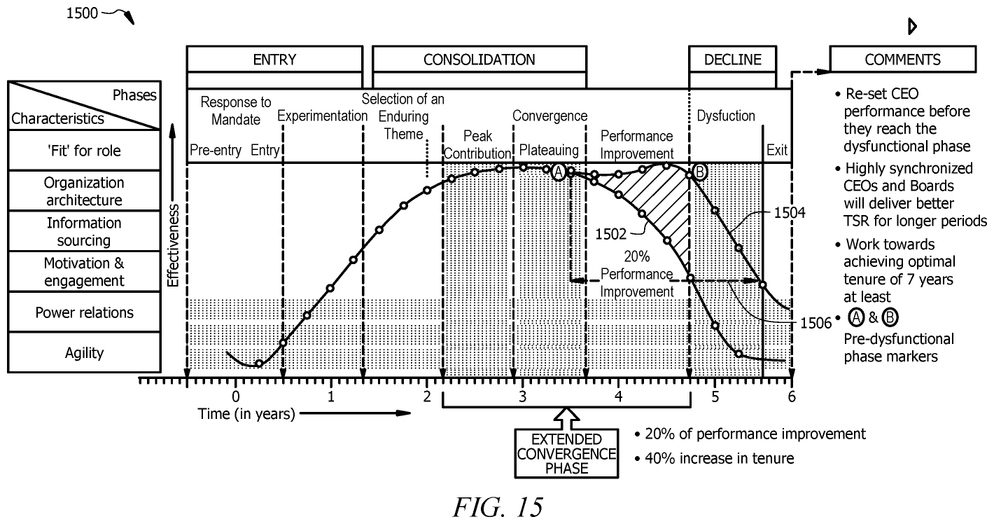

Referring to FIG. 15, an example of a user interface that displays CEO performance compared to a conceptual performance model is shown and designated 1500. User interface 1500 may include a CEO performance curve and a conceptual performance curve, which, in at least some implementations, converge for at least a portion of the CEO's tenure.

At some point in time during the CEO's tenure, the CEO performance curve may diverge from the conceptual performance curve. For example, CEO performance curve 1504, which is based on ratings from the CEO and the Board, may diverge from conceptual performance curve 1502, which is based on initial data. For example, due to decision making based on the information provided by the systems and techniques of the present disclosure, the CEO's performance may improve compared to the conceptual performance model. User interface 1500 may include one or more indicators, or other forms of information, to present the performance difference to a user. For example, indicator 1506 may be displayed to identify a 20% performance increase between CEO performance curve 1504 and conceptual performance curve 1502. Additionally or alternatively, the performance increase may correspond to an increase in the CEO's tenure, which may be visually represented within user interface 1500, such as via a change in positioning of the CEO's exit (or estimated exit), a visual indicator, or a combination thereof. Thus, user interface 1500 may enable the CEO, the Board, or an advisor to “reset” the CEO's performance before the CEO reaches a particular point (e.g., the dysfunctional phase) of the CEO's tenure, may increase the synchronization between the CEO and the Board (which may result in increased TSR), and may enable the CEO and the Board to extend the CEO's tenure, such as towards an estimated “optimal” tenure of at least seven years.

Although one or more of the disclosed figures may illustrate systems, apparatuses, methods, or a combination thereof, according to the teachings of the disclosure, the disclosure is not limited to these illustrated systems, apparatuses, methods, or a combination thereof. One or more functions or components of any of the disclosed figures as illustrated or described herein may be combined with one or more other portions of another function or component of the disclosed figures. Accordingly, no single implementation described herein should be construed as limiting and implementations of the disclosure may be suitably combined without departing from the teachings of the disclosure.

The steps of a method or algorithm described in connection with the implementations disclosed herein may be included directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient (e.g., non-transitory) storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

Although the present disclosure and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A method for using a predictive analytics engine to dynamically modify an interactive tool, the method comprising:
compiling candidate data;
initializing a predictive analytics engine based on at least a portion of the compiled candidate data and a conceptual performance model representative of an expected performance over a period of time;
processing, by the predictive analytics engine, a plurality of performance metrics to produce one or more predictive performance metrics; and
dynamically modifying an interactive tool based on the conceptual performance model and the plurality of performance metrics.

2. The method of claim 1, wherein the conceptual performance model comprises a curve based on the expected performance over the period of time.

3. The method of claim 1, wherein processing the plurality of performance metrics includes generating one or more ratings for corresponding performance metrics.

4. The method of claim 3, wherein the interactive tool is configured to display the one or more ratings with a first indicia if the one or more ratings satisfy a first threshold, a second indicia if the one or more ratings satisfy a second threshold, or a third indicia if the one or more ratings satisfy a third threshold.

5. The method of claim 4, wherein the first indicia comprises a first color, the second indicia comprises a second color, and the third indicia comprises a third color.

6. The method of claim 3, wherein processing the plurality of performance metrics further comprises applying one or more weights to the one or more ratings to generate one or more weighted ratings for corresponding performance metrics.

7. The method of claim 6, wherein the interactive tool is configured to receive user input indicative of the one or more weights.

8. The method of claim 6, wherein the interactive tool is configured to select one or more indicia for displaying the one or more weighted ratings based on satisfaction of one or more thresholds.

9. The method of claim 6, further comprising determining a coefficient value based on a number of a particular answer to a question compared to one or more thresholds and based on a minimum weight of the one or more weights.

10. The method of claim 9, wherein processing the performance metrics includes applying the coefficient value to one or more weighted ratings to generate one or more finalized ratings.

11. The method of claim 1, further comprising:
determining that a difference between an average of two highest ratings for a particular performance metric and an average of two lowest ratings for the particular performance metric satisfies a threshold; and
initiating a redetermination of ratings for the particular performance metric.

12. The method of claim 1, wherein modifying the interactive tool includes displaying the conceptual performance model and one or more decision nodes representing actual performance over the period of time.

13. The method of claim 12, wherein the interactive tool enables selection of one of the one or more decision nodes to initiate display of a performance measurement window that displays one or more performance metrics relative to expected values.

14. The method of claim 13, wherein the interactive tool enables selection of one of the performance metrics to initiate display of a sub-category window that displays one or more sub-category measurements.

15. The method of claim 12, wherein the interactive tool enables display of a three-dimensional graph of a subset of performance metrics at times corresponding to the one or more decision nodes.

16. A system for using a predictive analytics engine to dynamically modify an interactive tool, the system comprising:
at least one memory storing instructions; and
one or more processors coupled to the at least one memory, the one or more processors configured to execute the instructions to cause the one or more processors to:
compile candidate data;
initialize a predictive analytics engine based on at least a portion of the compiled candidate data and a conceptual performance model representative of an expected performance over a period of time;
process, by the predictive analytics engine, a plurality of performance metrics to produce one or more predictive performance metrics; and
dynamically modify an interactive tool based on the conceptual performance model and the plurality of performance metrics.

17. The system of claim 16, wherein the plurality of performance metrics include hard key performance indicators (KPIs), soft KPIs, ratings, a coefficient value, or a combination thereof.

18. A non-transitory computer-readable medium storing instructions that, when executed by a processor, cause the processor to perform operations comprising:
compiling candidate data;
initializing a predictive analytics engine based on at least a portion of the compiled candidate data and a conceptual performance model representative of an expected performance over a period of time;
processing, by the predictive analytics engine, a plurality of performance metrics to produce one or more predictive performance metrics; and
dynamically modifying an interactive tool based on the conceptual performance model and the plurality of performance metrics.

19. The non-transitory computer-readable medium of claim 18, wherein the modifying the interactive tool comprises causing the interactive tool to display the one or more predictive performance metrics.

20. The non-transitory computer-readable medium of claim 18, wherein the operations further comprise:
accessing pre-check rules to determine whether a difference between a first rating of a particular performance metric and a second rating of a particular performance metric satisfies a threshold; and
based on the difference failing to satisfy the threshold, initiating a redetermination of ratings for the particular performance metric.
